(19) United States
(12) Patent Application Publication
(10) Pub. No.: US 2023/0099270 A1
(43) Pub. Date: Mar. 30, 2023

(54) EXTERIOR MATERIAL FOR ELECTRICAL STORAGE DEVICE, METHOD FOR MANUFACTURING SAID EXTERIOR MATERIAL, AND ELECTRICAL STORAGE DEVICE

(71) Applicant: DAI NIPPON PRINTING CO., LTD., Tokyo (JP)

(72) Inventors: Atsushi NAGAI, Tokyo (JP); Toshiki KATOKU, Tokyo (JP); Tetsuya OJIRI, Tokyo (JP); Takayuki KOMAI, Tokyo (JP)

(73) Assignee: DAI NIPPON PRINTING CO., LTD., Tokyo (JP)

(21) Appl. No.: 17/798,722

(22) PCT Filed: Feb. 10, 2021
(86) PCT No.: PCT/JP2021/005082

§ 371 Date: Aug. 10, 2022

(30) Foreign Application Priority Data
Feb. 10, 2020 (JP) 2020-020685

(51) Int. Cl. H01M 50/126

(52) U.S. Cl. CPC H01M 50/126; H01M 50/105

(57) ABSTRACT

Provided is an exterior material for an electrical storage device that can be cold molded, the exterior material being configured from a layered body comprising at least a base material layer, an adhesive agent layer, a barrier layer, and a thermally fusible resin layer in the stated order, wherein the exterior material for an electrical storage device has exceptional moist heat resistance. An exterior material for an electrical storage device, the exterior material being configured from a layered body comprising at least a base material layer, an adhesive agent layer, a barrier layer, and a thermally fusible resin layer in the stated order, the adhesive agent layer having moist heat resistance, and it being possible to conduct cold molding on the layered body.

### TECHNICAL FIELD

The present disclosure relates to an exterior material for electrical storage devices, a method for manufacturing the exterior material for electrical storage devices, and an electrical storage device.

### BACKGROUND ART

Various types of electrical storage devices have been developed heretofore, and in every electrical storage device, a packaging material (exterior material) is an essential member for sealing electrical storage device elements such as an electrode and an electrolyte. Metallic exterior materials have been often used heretofore as exterior materials for electrical storage devices.

On the other hand, in recent years, electrical storage devices have been required to be diversified in shape and to be thinned and lightened with improvement of performance of electric cars, hybrid electric cars, personal computers, cameras, mobile phones and so on. However, metallic exterior materials for electrical storage devices that have often been heretofore used have the disadvantage that it is difficult to keep up with diversification in shape, and there is a limit on weight reduction.

Thus, in recent years, a film-shaped exterior material with a base material layer, an aluminum alloy foil layer and a heat-sealable resin layer laminated in this order has been proposed as an exterior material for electrical storage devices which is easily processed into diversified shapes and is capable of achieving thickness reduction and weight reduction (see, for example, Patent Document 1).

In such a film-shaped exterior material, generally, a concave portion is formed by cold molding, electrical storage device elements such as an electrode and an electrolytic solution are disposed in a space formed by the concave portion, and heat-sealable resin layers are heat-sealed to each other to obtain an electrical storage device in which electrical storage device elements are stored in an exterior material.

### PRIOR ART DOCUMENT

### Patent Document

Patent Document 1: Japanese Patent Laid-open Publication No. 2008-287971

### SUMMARY OF THE INVENTION

### Problems to be Solved by the Invention

A film-shaped exterior material for electrical storage devices with a base material layer, an aluminum alloy foil layer and a heat-sealable resin layer laminated in this order has been proposed as an exterior material which is used for electrical storage devices such as electric cars, hybrid electric cars, personal computers, cameras and mobile phones as described above. Further, use of such a film-shaped exterior material for electrical storage devices as an exterior material of an outdoor electrical storage device such as an energy storage system (ESS) is under consideration.

The outdoor electrical storage device is required to have a long service life of, for example, 10 years or more in a high-temperature and high-humidity environment because it is installed outdoors.

However, if an exterior material for electrical storage devices with a base material layer, an adhesive agent layer, a barrier layer and a heat-sealable resin layer laminated in this order is placed in a high-temperature and high-humidity environment, there is a problem that the adhesive strength of the adhesive agent layer bonding the base material layer and the barrier layer to each other decreases, and the base material layer and the barrier layer are peeled from each other.

In particular, such an exterior material for electrical storage devices has a concave portion formed by cold molding, and is used with an electrical storage device element stored in a space formed by the concave portion, so that it is required to have excellent moisture and heat resistance after cold molding. For example, an exterior material assumed to be used for conventional electrical storage devices for in-vehicle or mobile equipment is designed to have moisture and heat resistance, but an exterior material assumed to be used for outdoor electrical storage devices is required to have higher moisture and heat resistance after cold molding. In conventional conditions for moisture and heat resistance, the evaluation temperature in an accelerated test is, for example, about 65° C. to 85° C. The inventors of the present disclosure have considered that in order to further increase the service life of an outdoor electrical storage device, it is necessary to evaluate the durability with more severe conditions adopted as conditions for evaluation of moisture and heat resistance in an accelerated test.

Under these circumstances, a main object of the present disclosure is to provide a cold-moldable exterior material for electrical storage devices which includes a laminate including at least a base material layer, an adhesive agent layer, a barrier layer and a heat-sealable resin layer in this order and which has excellent moisture and heat resistance.

### Means for Solving the Problem

The inventors of the present disclosure have extensively conducted studies for achieving the above-described object. As a result, it has been found that when in a cold-moldable exterior material for electrical storage devices which includes a laminate including at least a base material layer, an adhesive agent layer, a barrier layer and a heat-sealable resin layer in this order, an adhesive agent layer having moisture and heat resistance is used as the adhesive agent layer for bonding the base material layer and the barrier layer to each other, the exterior material for electrical storage devices has moisture and heat resistance.

The present disclosure has been completed by further conducting studies based on the above-mentioned findings. That is, the present disclosure provides an invention of an aspect as described below.

An exterior material for electrical storage devices which includes a laminate including at least a base material layer, an adhesive agent layer, a barrier layer and a heat-sealable resin layer in this order,

the adhesive agent layer having moisture and heat resistance,

the laminate being cold-moldable.

### Advantages of the Invention

According to the present disclosure, it is possible to provide a cold-moldable exterior material for electrical storage devices which includes a laminate including at least a base material layer, an adhesive agent layer, a barrier layer and a heat-sealable resin layer in this order and which has excellent moisture and heat resistance. According to the present disclosure, it is also possible to provide a method for manufacturing an exterior material for electrical storage devices, and an electrical storage device.

### BRIEF DESCRIPTION OF THE DRAWINGS

FIG. 1 is a schematic diagram showing an example of a cross-sectional structure of an exterior material for electrical storage devices according to the present disclosure.

FIG. 2 is a schematic diagram showing an example of a cross-sectional structure of an exterior material for electrical storage devices according to the present disclosure.

FIG. 3 is a schematic diagram showing an example of a cross-sectional structure of an exterior material for electrical storage devices according to the present disclosure.

FIG. 4 is a schematic diagram for illustrating a method for housing an electrical storage device element in a packaging formed from an exterior material for electrical storage devices according to the present disclosure.

FIG. 5 is a schematic diagram for illustrating a direction in which a heat shrinkage ratio and a moisture and heat shrinkage ratio.

FIG. 6 is a schematic diagram for illustrating a method for preparing a test sample in evaluation of moisture and heat resistance.

FIG. 7 is a schematic diagram for illustrating a method for evaluation of moisture and heat resistance.

### EMBODIMENTS OF THE INVENTION

An exterior material for electrical storage devices includes a laminate including at least a base material layer, an adhesive agent layer, a barrier layer and a heat-sealable resin layer in this order, the adhesive agent layer has moisture and heat resistance, and the laminate is cold-moldable. The exterior material for electrical storage devices according to the present disclosure has the above-mentioned configuration. That is, it is possible to provide a cold-moldable exterior material for electrical storage devices which includes a laminate including at least a base material layer, an adhesive agent layer, a barrier layer and a heat-sealable resin layer in this order and which has excellent moisture and heat resistance.

Hereinafter, the exterior material for electrical storage devices according to the present disclosure will be described in detail. In this specification, a numerical range indicated by the term “A to B” means “A or more” and “B or less”. For example, the expression of “2 to 15 mm” means 2 mm or more and 15 mm or less. In this specification, the thickness of each layer forming the laminate is a value rounded to the nearest integer.

### 1. Laminated Structure and Physical Property of Exterior Material for Electrical Storage Devices

As shown in, for example, FIG. 1, an exterior material 10 for electrical storage devices according to the present disclosure includes a laminate including at least a base material layer 1, an adhesive agent layer 2, a barrier layer 3 and a heat-sealable resin layer 4 in this order. In the exterior material 10 for electrical storage devices, the base material layer 1 is on the outermost layer side, and the heat-sealable resin layer 4 is an innermost layer. In construction of the electrical storage device using the exterior material 10 for electrical storage devices and electrical storage device elements, the electrical storage device elements are put in a space formed by heat-sealing the peripheral portions of heat-sealable resin layers 4 of the exterior material 10 for electrical storage devices which face each other. In the laminate forming the exterior material 10 for electrical storage devices according to the present disclosure, the heat-sealable resin layer 4 is on the inner side with respect to the barrier layer 3, and the base material layer 1 is on the outer side with respect to the barrier layer 3.

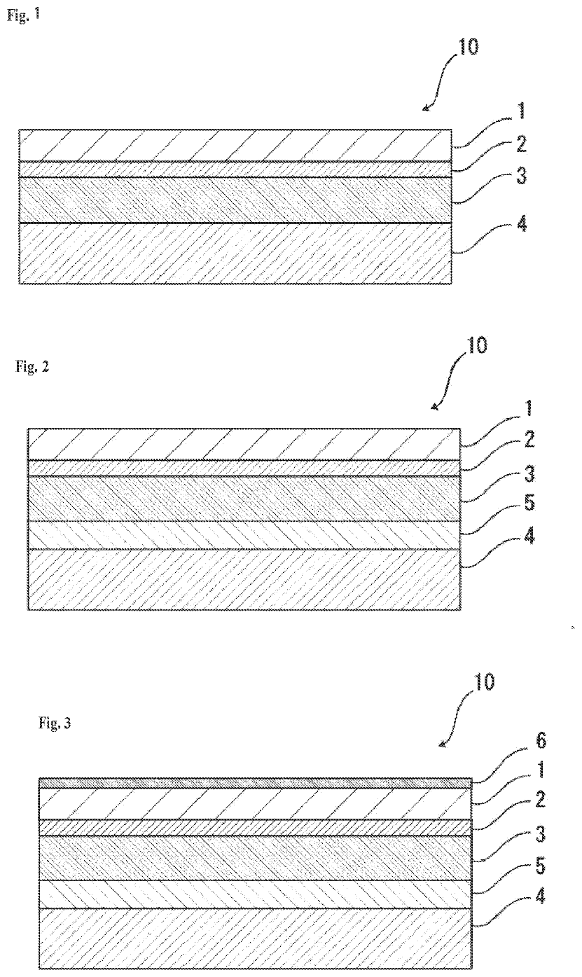

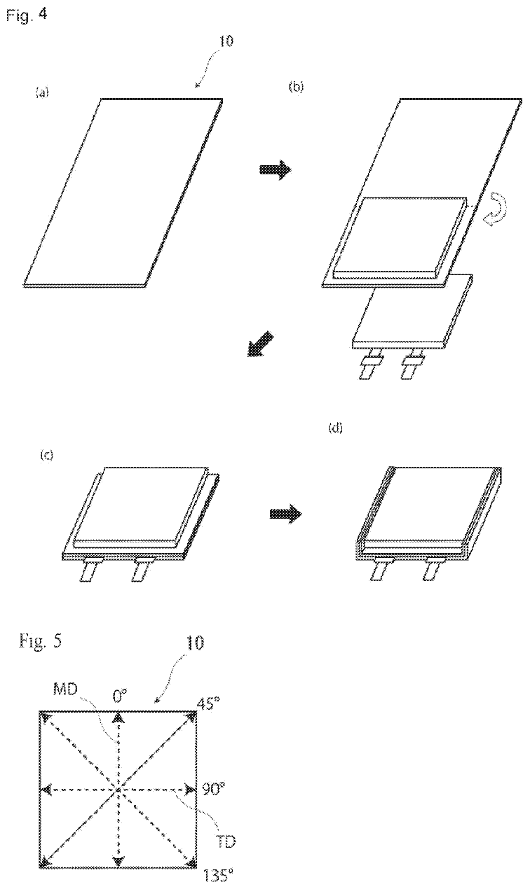

As shown in, for example, FIGS. 2 and 3, the exterior material 10 for electrical storage devices may have an adhesive layer 5 between the barrier layer 3 and the heat-sealable resin layer 4 if necessary for the purpose of, for example, improving bondability between these layers. As shown in FIG. 4, a surface coating layer 6 or the like may be provided on the outside of the base material layer 1 (on a side opposite to the heat-sealable resin layer 4 side) if necessary.

The thickness of the laminate forming the exterior material 10 for electrical storage devices is not particularly limited, and is preferably about 180 μm or less, about 155 μm or less, or about 120 μm or less, from the viewpoint of cost reduction, energy density improvement, and the like. The thickness of the laminate forming the exterior material 10 for electrical storage devices is preferably about 35 μm or more, about 45 μm or more, or about 60 μm or more, from the viewpoint of maintaining the function of an exterior material for electrical storage devices, which is protection of an electrical storage device element. The laminate forming the exterior material 10 for electrical storage devices is preferably in the range of, for example, about 35 to 180 μm, about 35 to 155 μm, about 35 to 120 μm, about 45 to 180 μm, about 45 to 155 μm, about 45 to 120 μm, about 60 to 180 μm, about 60 to 155 μm, and about 60 to 120 μm, particularly preferably about 60 to 155 μm.

In the exterior material 10 for electrical storage devices, the ratio of the total thickness of the base material layer 1, the adhesive agent layer 2, the barrier layer 3, the adhesive layer 5 provided if necessary, the heat-sealable resin layer 4, and the surface coating layer 6 provided if necessary to the thickness (total thickness) of the laminate forming the exterior material 10 for electrical storage devices is preferably 90% or more, more preferably 95% or more, still more preferably 98% or more. As a specific example, when the exterior material 10 for electrical storage devices according to the present disclosure includes the base material layer 1, the adhesive agent layer 2, the barrier layer 3, the adhesive layer 5 and the heat-sealable resin layer 4, the ratio of the total thickness of these layers to the thickness (total thickness) of the laminate forming the exterior material 10 for electrical storage devices is preferably 90% or more, more preferably 95% or more, still more preferably 98% or more. In addition, when the exterior material 10 for electrical storage devices according to the present disclosure is a laminate including the base material layer 1, the adhesive agent layer 2, the barrier layer 3 and the heat-sealable resin layer 4, the ratio of the total thickness of these layers to the thickness (total thickness) of the laminate forming the exterior material 10 for electrical storage devices may be, for example, 80% or more, preferably 90% or more, more preferably 95% or more, still more preferably 98% or more.

In the exterior material for electrical storage devices, Machine Direction (MD) and Transverse Direction (TD) in the process for manufacturing thereof can be discriminated from each other for the barrier layer 3 described later. For example, when the barrier layer 3 includes an aluminum alloy foil, linear streaks called rolling indentations are formed on the surface of the aluminum alloy foil in the rolling direction (RD) of the aluminum alloy foil. Since the rolling indentations extend along the rolling direction, the rolling direction of the aluminum alloy foil can be known by observing the surface of the aluminum alloy foil. In the process for manufacturing of the laminate, the MD of the laminate and the RD of the aluminum alloy foil normally coincides with each other, and therefore by observing the surface of the aluminum alloy foil of the laminate to identify the rolling direction (RD) of the aluminum foil, the MD of the laminate can be identified. Since the TD of the laminate is perpendicular to the MD of the laminate, the TD of the laminate can be identified.

If the MD of the exterior material for electrical storage devices cannot be identified by the rolling indentations of the aluminum alloy foil, the MD can be identified by the following method. As a method for identifying the MD of the exterior material for electrical storage devices, a cross-section of the heat-sealable resin layer of the exterior material for electrical storage devices is observed with an electron microscope to examine a sea-island structure, and a direction parallel to a cross-section having the largest average of diameters of island shapes in a direction perpendicular to the thickness direction of the heat-sealable resin layer can be determined as the MD. Specifically, a cross-section in the length direction of the heat-sealable resin layer and cross-sections (a total of 10 cross-sections) at angular intervals of 10 degrees from a direction parallel to the cross-section in the length direction to a direction perpendicular to the cross-section in the length direction are observed with an electron microscope photograph to examine sea-island structures. Next, in each cross section, the shape of each island is observed. For the shape of each island, the linear distance between the leftmost end in a direction perpendicular to the thickness direction of the heat-sealable resin layer and the rightmost end in the perpendicular direction is defined as a diameter y. In each cross-section, the average of the top 20 diameters y in descending order of the diameter y of the island shape is calculated. The direction parallel to a cross-section having the largest average of the diameters y of the island shapes is determined as MD.

In the exterior material for electrical storage devices according to the present disclosure, an adhesive agent layer described later has moisture and heat resistance. The exterior material for electrical storage devices according to the present disclosure is cold-moldable.

Here, the phrase “the adhesive agent layer 2 has moisture and heat resistance” specifically means having moisture and heat resistance preferably when the moisture and heat resistance is evaluated under the accelerated test condition of a saturated water vapor environment at a temperature of 120° C. (the test duration is, for example, 10 hours or more as described later). More specifically, when the following method for evaluation of moisture and heat resistance is used to examine delamination between the base material layer 1 and the barrier layer 3 in the exterior material 10 for electrical storage devices after cold molding, the number of test samples undergoing the delamination, among a total of 12 samples of the exterior material for electrical storage devices, is preferably 4 or less, more preferably 3 or less, still more preferably 2 or less, particularly preferably 0. The following (method for evaluation of moisture and heat resistance) corresponds to an evaluation method in which the sample is left standing in an autoclave for 10 hours in an example described later (moisture and heat resistance evaluation 3: a saturated water vapor environment at a temperature of 120° C.).

### (Method for Evaluation of Moisture and Heat Resistance)

The exterior material for electrical storage devices is prepared as a test sample having a rectangular shape in plan view and having a size of 120 mm in the transverse direction and 80 mm in the machine direction. The number of the test samples is 12. Next, as a mold for cold molding, a male mold having a rectangular shape in plan view and having a size of 54.5 mm in the transverse direction and 31.6 mm in the machine direction, and a female mold having a clearance of 0.5 mm from the male mold are prepared. In the male mold, the surface of a ridge line portion has a roughness in maximum height (nominal value of Rz) of 1.6 μm as specified in Appendix 1 (Reference) of JIS B 0659-1: 2002, Comparative Surface Roughness Standard Specimen, Table 2), the surface of a non-ridge line portion has a roughness in maximum height (nominal value of Rz) of 3.2 μm as specified in Appendix 1 (Reference) of JIS B 0659-1: 2002, Comparative Surface Roughness Standard Specimen, Table 2), the curvature radius R of the corner is 2.0 mm, and the curvature radius R of the ridge line is 1.0 mm. In the female mold, the surface has a roughness in maximum height (nominal value of Rz) of 3.2 μm as specified in Appendix 1 (Reference) of JIS B 0659-1: 2002, Comparative Surface Roughness Standard Specimen, Table 2), the curvature radius R of the corner is 2.0 mm, and the curvature radius R of the ridge line is 1.0 mm. The test sample is placed on the female mold such that the heat-sealable resin layer of the test sample is located on the male mold side. Next, the test sample is pressed at a surface pressure of 0.13 MPa and subjected to cold molding by drawing in one stage (evaluation is performed with the molding depth appropriately adjusted to be within the range of 5.0 mm to 7.0 mm; for example, the molding depth is 5.0 mm, 5.5 mm, 6.0 mm, 6.5 mm, or 7.0 mm; and for example, when the base material layer includes a laminate of a polyester film and a polyamide film, the molding depth is 5.0 mm, and for example, when the base material layer includes a polyamide film, the molding depth is 7.0 mm). Next, the test sample after cold molding is put in an autoclave. The environment of the inside of the autoclave is set to a saturated water vapor environment at a temperature of 120° C., and the test sample is left standing for 10 hours. Next, the test sample is taken out from the autoclave, and the interface between the base material layer and the barrier layer is visually observed to examine whether or not delamination occurs between these layers. The portion where delamination is most likely to occur between the layers is a corner close to the flange side of the molding concave portion of the test sample (portion of d in FIG. 7). In such a portion, stress is likely to be applied to each layer of the laminate by cold molding, and in particular, the base material layer 1 is likely to undergo heat shrinkage or moisture and heat shrinkage at the portion, so that delamination occurs between the layers if the adhesive agent layer 2 contacting the base material layer 1 does not have moisture and heat resistance.

Further, when the exterior material for electrical storage devices according to the present disclosure is left standing in an autoclave for 12 hours in the method for evaluation of moisture and heat resistance, the number of test samples undergoing the delamination, among a total of 12 samples of the exterior material for electrical storage devices, is preferably 4 or less, more preferably 3 or less, still more preferably 2 or less, particularly preferably 0.

In the exterior material 10 for electrical storage devices according to the present disclosure, the peeling strength at room temperature (25° C.) is preferably 5.0 N/15 mm or more as measured using the following method for heat resistance evaluation 1. The peeling strength at room temperature (25° C.) is preferably high, and the upper limit thereof is, for example, 12.0 N/15 mm or less. In the exterior material 10 for electrical storage devices according to the present disclosure, the peeling strength at 120° C. is preferably 3.0 N/15 mm or more as measured using the following method for heat resistance evaluation 1. The peeling strength at 120° C. is preferably high, and the upper limit thereof is, for example, 8.0 N/15 mm or less.

The ratio (%) of the peeling strength at a temperature of 120° C. to the peeling strength at room temperature is preferably 25% or more, more preferably 30% or more, still more preferably 40% or more, particularly preferably 50% or more. The ratio of the peeling strength is, for example, 90% or less, 80% or less, or 70% or less.

### <Heat Resistance Evaluation 1>

As specified in JIS K 7127: 1999, the peeling strength of the exterior material for electrical storage devices at room temperature (25° C.) or 120° C. is measured as follows. From the exterior material for electrical storage devices, a test sample is cut into a strip shape having a width of 15 mm (transverse direction) and a length of 150 mm (machine direction). The MD of the exterior material for electrical storage devices corresponds to the rolling direction (RD) of the aluminum alloy foil, the TD of the exterior material for electrical storage devices corresponds to the TD of the aluminum alloy foil. Next, at a short-side portion of the test sample on one side thereof, the test sample is delaminated at the interface between the adhesive agent layer and the barrier layer to the extent that the test sample can be gripped with a gripping tool of a tensile tester (e.g. AG-X plus (trade name) manufactured by Shimadzu Corporation) on each of a side where the base material layer is present and a side where the barrier layer is present, thereby obtaining a measuring test sample. Next, the measuring test sample is attached to the tensile tester and left to stand at each measurement temperature for 2 minutes, and subsequently, the peeling strength (N/15 mm) between the base material layer and the barrier layer is measured by the tensile tester under the conditions of peeling by 180°, a tensile speed of 50 mm/min, and a gauge length of 50 mm. The strength at a gauge length of 57 mm is taken as a peeling strength (N/15 mm), and the average of values obtained by measuring the peeling strength (N/15 mm) three times is evaluated as a peeling strength (N/15 mm) at each temperature.

It is preferable that the exterior material for electrical storage devices according to the present disclosure is evaluated as having high heat resistance as an exterior material for electrical storage devices in the following heat resistance evaluation 2.

### <Heat Resistance Evaluation 2>

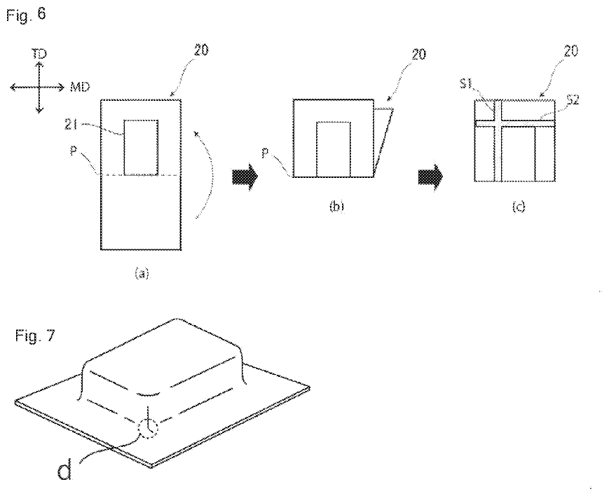

In the same manner as in <Evaluation of moldability> described later, a test sample obtained by cutting each exterior material for electrical storage devices to a rectangle having a length of 90 mm (machine direction)×a width of 160 mm (transverse direction) is subjected to cold molding using the above-described mold. Next, as shown in the schematic diagram of FIG. 6, the test sample after cold molding is bent at the position of broken line P in such a manner that a molding concave portion 21 of a test sample 20 is on the inner side (heat-sealable resin layers face each other) (FIGS. 6(a) and 6(b)). Next, along the outer edge of the molding concave portion, heat sealing is performed at two positions in the transverse direction and the machine direction in this order (FIG. 6(c)). In FIG. 6, the heat-sealed portion S1 in the transverse direction and the heat-sealed portion S2 in the machine direction are each indicated by a shaded region. The heat-sealing conditions are set to 190° C. or 210° C., a surface pressure of 1.0 MPa, 3 seconds, and a seal width of 7 mm. For the heat-sealed test sample, whether or not delamination between the base material layer and the barrier layer (delamination of the base material layer) occurs is visually examined, and the ratio of test samples undergoing the delamination in 10 test samples is determined. When the ratio of test samples undergoing the delamination is in the range of 0/10 to 4/10, the cold-molded exterior material for electrical storage devices has high heat resistance.

In the exterior material for electrical storage devices according to the present disclosure, the limit molding depth measured by the following method for evaluation of moldability is preferably 4.0 mm or more, more preferably 5.0 mm or more when a slipping agent is not present on both surfaces. The limit molding depth is, for example, 10.0 mm or less. When a slipping agent is present on both surfaces, the limit molding depth is preferably 5.0 mm or more, more preferably 6.0 mm or more. The limit molding depth is, for example, 12.0 mm or less.

### <Evaluation of Moldability>

For the exterior material for electrical storage devices, a test sample in which erucic acid amide is applied as a slipping agent to each of both surfaces (the surface of the base material layer and the surface of the heat-sealable resin layer) of the exterior material for electrical storage devices (with slipping agent) and a test sample in which the slipping agent is not applied (without slipping agent) are prepared, and subjected to cold molding. First, the exterior material for electrical storage devices is cut to a rectangle having a length of 90 mm (machine direction) and a width of 150 mm (transverse direction) to obtain a test sample. The MD of the exterior material for electrical storage devices corresponds to the rolling direction (RD) of the aluminum alloy foil, the TD of the exterior material for electrical storage devices corresponds to the TD of the aluminum alloy foil. Next, using a rectangular mold having an opening size of 31.6 mm (machine direction)×54.5 mm (transverse direction) (female; the surface has a roughness in maximum height (nominal value of Rz) of 3.2 μm as specified in Appendix 1 (Reference) of JIS B 0659-1: 2002, Comparative Surface Roughness Standard Specimen, Table 2; the curvature radius R of the corner is 2.0 mm; and the curvature radius R of the ridge line is 1.0 mm), and a corresponding mold (male; surface of the ridge line portion has a roughness in maximum height (nominal value of Rz) of 1.6 μm as specified in Appendix 1 (Reference) of JIS B 0659-1: 2002, Comparative Surface Roughness Standard Specimen, Table 2; the surface of a non-ridge line portion has a roughness in maximum height (nominal value of Rz) of 3.2 μm as specified in Appendix 1 (Reference) of JIS B 0659-1: 2002, Comparative Surface Roughness Standard Specimen, Table 2; the curvature radius R of the corner is 2.0 mm; and the curvature radius R of the ridge line is 1.0 mm), each sample is subjected to cold molding (draw molding in one stage) at each molding depth (5.0 mm to 8.5 mm) under a pressing pressure (surface pressure) of 0.25 MPa in an environment at 25° C. This procedure is carried out for 10 test samples. At this time, the molding is performed at room temperature (25° C.) with the test sample placed on the female mold in such a manner that the heat-sealable resin layer is located on the male mold side. The male mold and the female mold has a clearance of 0.3 mm. For the cold-molded exterior material for electrical storage devices, the deepest of depths at which none of the 10 test samples has pinholes and cracks in the aluminum alloy foil is defined as A mm, and the number of test samples having pinholes etc. at the shallowest of depths where pinholes etc. are generated in the aluminum alloy foil is defined as B. The value calculated from the following equation is rounded off to one decimal place, and the resulting value is defined as a limit molding depth of the exterior material for electrical storage devices.

Limit molding depth=A mm+(0.5 mm/10 pieces)×(10 pieces−B pieces)

The phrase “the exterior material for electrical storage devices according to the present disclosure is cold-moldable specifically means that the limit molding depth measured by the following method for evaluation of moldability is 4.0 mm or more, more preferably 5.0 mm or more when a slipping agent is not present on either of both surfaces. When a slipping agent is present on both surfaces, the limit molding depth is preferably 5.0 mm or more, more preferably 6.0 mm or more.

### 2. Layers Forming Exterior Material for Electrical Storage Devices

### [Base Material Layer 1]

In the present disclosure, the base material layer 1 is a layer provided for the purpose of, for example, exhibiting a function as a base material of the exterior material for electrical storage devices. The base material layer 1 is located on the outer layer side of the exterior material for electrical storage devices.

The material that forms the base material layer 1 is not particularly limited as long as it has a function as a base material, i.e. at least insulation quality. The base material layer 1 can be formed using, for example, a resin, and the resin may contain additives described later.

When the base material layer 1 is formed of a resin, the base material layer 1 may be, for example, a resin film formed of a resin, or may be formed by applying a resin. The resin film may be an unstretched film or a stretched film. Examples of the stretched film include uniaxially stretched films and biaxially stretched films, and biaxially stretched films are preferable. Examples of the stretching method for forming a biaxially stretched film include a sequential biaxial stretching method, an inflation method, and a simultaneous biaxial stretching method. Examples of the method for applying a resin include a roll coating method, a gravure coating method and an extrusion coating method.

Examples of the resin that forms the base material layer 1 include resins such as polyester, polyamide, polyolefin, epoxy resin, acrylic resin, fluororesin, polyurethane, silicone resin and phenol resin, and modified products of these resins. The resin that forms the base material layer 1 may be a copolymer of these resins or a modified product of the copolymer. Further, a mixture of these resins may be used.

Of these resins, polyester and polyamide are preferable as resins that form the base material layer 1.

Specific examples of the polyester resin include polyethylene terephthalate, polybutylene terephthalate, polyethylene naphthalate, polybutylene naphthalate, polyethylene isophthalate, and copolyesters. Examples of the copolyester include copolyesters having ethylene terephthalate as a main repeating unit. Specific examples thereof include copolymer polyesters that are polymerized with ethylene isophthalate and include ethylene terephthalate as a main repeating unit (hereinafter, abbreviated as follows after polyethylene(terephthalate/isophthalate)), polyethylene(terephthalate/adipate), polyethylene(terephthalate/sodium sulfoisophthalate), polyethylene(terephthalate/sodium isophthalate), polyethylene (terephthalate/phenyl-dicarboxylate) and polyethylene(terephthalate/decane dicarboxylate). These polyesters may be used alone, or may be used in combination of two or more thereof.

Specific examples of the polyamide include polyamides such as aliphatic polyamides such as nylon 6, nylon 66, nylon 610, nylon 12, nylon 46, and copolymers of nylon 6 and nylon 66; hexamethylenediamine-isophthalic acid-terephthalic acid copolymerization polyamides containing a structural unit derived from terephthalic acid and/or isophthalic acid, such as nylon 61, nylon 6T, nylon 61T and nylon 616T (I denotes isophthalic acid and T denotes terephthalic acid), and polyamides containing aromatics, such as polyamide MXD6 (polymethaxylylene adipamide); cycloaliphatic polyamides such as polyamide PACM6 (polybis(4-aminocyclohexyl)methaneadipamide; polyamides copolymerized with a lactam component or an isocyanate component such as 4,4 [symbol] diphenylmethane-diisocyanate, and polyester amide copolymers and polyether ester amide copolymers as copolymers of a copolymerization polyamide and a polyester or a polyalkylene ether glycol; and copolymers thereof. These polyamides may be used alone, or may be used in combination of two or more thereof.

The base material layer 1 contains preferably at least one of a polyester film, a polyamide film and a polyolefin film, preferably at least one of a stretched polyester film, a stretched polyamide film and a stretched polyolefin film, still more preferably at least one of a stretched polyethylene terephthalate film, a stretched polybutylene terephthalate film, a stretched nylon film and a stretched polypropylene film, even more preferably at least one of a biaxially stretched polyethylene terephthalate film, a biaxially stretched polybutylene terephthalate film, a biaxially stretched nylon film, and a biaxially stretched polypropylene film.

The base material layer 1 may be a single layer, or may include two or more layers. When the base material layer 1 includes two or more layers, the base material layer 1 may be a laminate obtained by laminating resin films with an adhesive or the like, or a resin film laminate obtained by co-extruding resins to form two or more layers. The resin film laminate obtained by co-extruding resins to form two or more layers may be used as the base material layer 1 in an unstretched state, or may be uniaxially stretched or biaxially stretched and used as the base material layer 1.

Specific examples of the resin film laminate with two or more layers in the base material layer 1 include laminates of a polyester film and a nylon film, nylon film laminates with two or more layers, and polyester film laminates with two or more layers. Laminates of a stretched nylon film and a stretched polyester film, stretched nylon film laminates with two or more layers, and stretched polyester film laminates with two or more layers are preferable. For example, when the base material layer 1 is a resin film laminate with two layers, the base material layer 1 is preferably a laminate of a polyester resin film and a polyester resin film, a laminate of a polyamide resin film and a polyamide resin film, or a laminate of a polyester resin film and a polyamide resin film, more preferably a laminate of a polyethylene terephthalate film and a polyethylene terephthalate film, a laminate of a nylon film and a nylon film, or a laminate of a polyethylene terephthalate film and a nylon film. As a general tendency of films, a polyester resin film has a lower heat shrinkage ratio and lower moisture absorbency than a polyamide resin film, and therefore heat shrinkage and moisture absorption of a polyamide film can be suppressed when a polyester resin film is located outside the polyamide film. It is preferable that as the polyamide film of the base material layer, a polyamide film having a heat shrinkage ratio and a moisture and heat shrinkage ratio described later is used. Since the polyester resin is hardly discolored even in the case where for example, an electrolytic solution is deposited on the surface, it is preferable that the polyester resin film is located at the outermost layer of the base material layer 1 when the base material layer 1 is a resin film laminate with two or more layers.

When the base material layer 1 is a resin film laminate with two or more layers, the two or more resin films may be laminated with an adhesive interposed therebetween. Specific examples of the preferred adhesive include the same adhesives as those exemplified for the adhesive agent layer 2 described later (i.e. an adhesive having moisture and heat resistance after curing). The method for laminating a resin film having two or more layers is not particularly limited, and a known method can be employed. Examples thereof include a dry lamination method, a sand lamination method, an extrusion lamination method and a thermal lamination method, and a dry lamination method is preferable. When the resin film is laminated by a dry lamination method, it is preferable to use a polyurethane adhesive as the adhesive. Here, the thickness of the adhesive is, for example, about 2 to 5 μm. In addition, the lamination may be performed with an anchor coat layer formed on the resin film. Examples of the anchor coat layer include the same adhesives as those exemplified for the adhesive agent layer 2 described later. Here, the thickness of the anchor coat layer is, for example, about 0.01 to 1.0 μm.

From the viewpoint of suitably improving the moldability and the moisture and heat resistance of the exterior material for electrical storage devices according to the present disclosure, the heat shrinkage ratio of the resin film in the base material layer is preferably 5.0% or less, more preferably 3.5% or less, still more preferably 3.0% or less. From the viewpoint of suitably suppressing delamination between the base material layer 1 and the barrier layer 3 in a moist and hot environment, it is preferable that a resin film having a heat shrinkage ratio as described above is located closest to the barrier layer in the base material layer. From the viewpoint of suitably improving the moldability and the moisture and heat resistance of the exterior material for electrical storage devices according to the present disclosure, and suitably suppressing delamination between the base material layer 1 and the barrier layer 3 in a moist and hot environment, it is preferable to satisfy the heat shrinkage ratio in four directions: machine direction, transverse direction, 45° direction and 135° direction of the base material layer. In addition, it is desirable that the heat shrinkage ratios in these four directions have high consistency. The heat shrinkage ratio is preferably 5.0% or less, preferably 3.5% or less, preferably 3.0% or less, more preferably 2.5% or less, still more preferably 2.0% or less, in all of the machine direction, the transverse direction, the 45° direction and the 135° direction of the base material layer 1. The heat shrinkage ratio is preferably low, and for example, the lower limit thereof is preferably 0.1%, more preferably 0%. For the heat shrinkage ratio, the difference between the value of the highest heat shrinkage ratio and the value of the lowest heat shrinkage ratio of the base material layer 1 in the four directions: machine direction, transverse direction, 45° direction and 135° direction of the base material layer is preferably 5.0% or less, preferably 3.5% or less, preferably 3.0% or less, more preferably 2.5% or less, still more preferably 2.0% or less. The difference between the heat shrinkage ratios is preferably low, and for example, the lower limit thereof is preferably 0.1%, more preferably 0%. Heat shrinkage ratios in the 45° direction and the 135° direction are measured, where a direction along the machine direction is set to a 0° direction and a direction along the transverse direction orthogonal to the machine direction is set to a 90° direction as shown in FIG. 5. In the measurement of the heat shrinkage ratio, the 0° direction coincides with the 180° direction. The resin film having such a heat shrinkage ratio is preferably a polyamide film, more preferably a nylon film, still more preferably a stretched nylon film. The method for measuring the heat shrinkage ratio of the base material layer is as follows.

### (Method for Measuring Heat Shrinkage Ratio of Base Material Layer)

In a method conforming to the provisions of JIS Z 1714: 2009, the heat shrinkage ratio (machine direction, transverse direction, 45° direction and 135° direction) is measured under the conditions of a test temperature of 160° C. and a heating time of 30 minutes with the base material layer as a test sample. The average of values determined for the three test samples is taken as a heat shrinkage ratio.

From the viewpoint of suitably improving the moldability and the moisture and heat resistance of the exterior material for electrical storage devices according to the present disclosure, the moisture and heat shrinkage ratio of the resin film in the base material layer is preferably 3.0% or less, more preferably 2.5% or less. It is preferable to satisfy the moisture and heat shrinkage ratio of the base material layer in four directions: machine direction, transverse direction, 45° direction and 135° direction. In addition, it is desirable that the moisture and heat shrinkage ratios in these four directions have high consistency. The moisture and heat shrinkage ratio of the base material layer 1 is preferably 3.0% or less, preferably 2.5% or less, preferably 2.0% or less, more preferably 1.9% or less, still more preferably 1.8% or less, in all of the machine direction, the transverse direction, the 45° direction and the 135° direction. The moisture and heat shrinkage ratio is preferably low, and for example, the lower limit thereof is preferably 0.1%, more preferably 0%. For the moisture and heat shrinkage ratio, the difference between the value of the highest moisture and heat shrinkage ratio and the value of the lowest moisture and heat shrinkage ratio of the base material layer 1 in the four directions: machine direction, transverse direction, 45° direction and 135° direction of the base material layer is preferably 3.5% or less, preferably 2.0% or less, more preferably 1.5% or less, still more preferably 1.2% or less. The difference between the moisture and heat shrinkage ratios is preferably low, and for example, the lower limit thereof is preferably 0.1%, more preferably 0%. The resin film having such a moisture and heat shrinkage ratio is preferably a polyamide film, more preferably a nylon film, still more preferably a stretched nylon film. The method for measuring the moisture and heat shrinkage ratio of the base material layer is as follows.

### (Method for Measuring Moisture and Heat Shrinkage Ratio of Base Material Layer)

In a method conforming to the provisions of JIS Z 1714: 2009, the heat shrinkage ratio (machine direction, transverse direction, 45° direction and 135° direction) is measured under the conditions of a test temperature of 85° C., a relative humidity of 85% RH and a heating time of 2 hours with the base material layer as a test sample. The average of values determined for the three test samples is taken as a moisture and heat shrinkage ratio.

Additives such as a slipping agent, a flame retardant, an antiblocking agent, an antioxidant, a light stabilizer, a tackifier and an antistatic agent may be present on at least one of the surface of the base material layer 1 and/or inside the base material layer 1. The additives may be used alone, or may be used in combination of two or more thereof.

In the present disclosure, it is preferable that a slipping agent is present on the surface of the base material layer 1 from the viewpoint of enhancing the moldability of the exterior material for electrical storage devices. The slipping agent is not particularly limited, and is preferably an amide-based slipping agent. Specific examples of the amide-based slipping agent include saturated fatty acid amides, unsaturated fatty acid amides, substituted amides, methylol amides, saturated fatty acid bisamides, unsaturated fatty acid bisamides, fatty acid ester amides, and aromatic bisamides. Specific examples of the saturated fatty acid amide include lauric acid amide, palmitic acid amide, stearic acid amide, behenic acid amide, and hydroxystearic acid amide. Specific examples of unsaturated fatty acid amide include oleic acid amide and erucic acid amide. Specific examples of the substituted amide include N-oleylpalmitic acid amide, N-stearyl stearic acid amide, N-stearyl oleic acid amide, N-oleyl stearic acid amide, and N-stearyl erucic acid amide. Specific examples of the methylolamide include methylolstearic acid amide. Specific examples of the saturated fatty acid bisamide include methylenebisstearic acid amide, ethylenebiscapric acid amide, ethylenebislauric acid amide, ethylenebisstearic acid amide, ethylenebishydroxystearic acid amide, ethylenebisbehenic acid amide, hexamethylenebisstearic acid amide, hexamethylenehydroxystearic acid amide, N,N′-distearyl adipic acid amide, and N,N′-distearyl sebacic acid amide. Specific examples of the unsaturated fatty acid bisamide include ethylenebisoleic acid amide, ethylenebiserucic acid amide, hexamethylenebisoleic acid amide, N,N [symbol] dioleyladipic acid amide, and N,N [symbol] dioleylsebacic acid amide. Specific examples of the fatty acid ester amide include stearoamideethyl stearate. Specific examples of the aromatic bisamide include m-xylylenebisstearic acid amide, m-xylylenebishydroxystearic acid amide, and N,N [symbol] distearylisophthalic acid amide. The slipping agents may be used alone, or may be used in combination of two or more thereof.

When the slipping agent is present on the surface of the base material layer 1, the amount of the slipping agent present is not particularly limited, and is preferably about 3 mg/m² or more, more preferably about 4 to 15 mg/m², still more preferably about 5 to 14 mg/m².

The slipping agent present on the surface of the base material layer 1 may be one obtained by exuding the slipping agent contained in the resin forming the base material layer 1, or one obtained by applying the slipping agent to the surface of the base material layer 1.

The thickness of the base material layer 1 is not particularly limited as long as it performs a function as a base material, and from the viewpoint of suitably improving the moldability and the moisture and heat resistance, the thickness is preferably about 3 μm or more, more preferably about 5 μm or more, still more preferably about 8 μm or more, particularly preferably about 10 μm or more. The thickness of the base material layer 1 is preferably about 50 μm or less, more preferably about 40 μm or less, still more preferably about 35 μm or less. The thicknesses of the thickness of the base material layer 1 is preferably in the range of about 3 to 50 μm, about 3 to 40 μm, about 3 to 45 μm, about 3 to 35 μm, about 5 to 50 μm, about 5 to 40 μm, about 5 to 45 μm, about 5 to 35 μm, about 8 to 50 μm, about 8 to 40 μm, about 8 to 45 μm, or about 8 to 35 μm, about 10 to 50 μm, about 10 to 40 μm, about 10 to 45 μm, or about 10 to 35 μm.

When the base material layer 1 is a laminate of two or more resin layers, the thickness of the resin film forming each layer is preferably about 2 μm or more, more preferably about 3 μm or more, still more preferably about 6 μm or more, particularly preferably about 8 μm or more. The thickness of the base material layer 1 is preferably about 30 μm or less, more preferably about 25 μm or less, still more preferably about 20 μm or less. The total thickness of the base material layer 1 is preferably in the range of about 2 to 30 μm, about 2 to 25 μm, about 2 to 20 μm, about 3 to 30 μm, about 3 to 25 μm, about 3 to 20 μm, about 6 to 30 μm, about 6 to 25 μm, about 6 to 20 μm, about 8 to 30 μm, about 8 to 25 μm, or about 8 to 20 μm.

Examples of the particularly preferred configuration of the base material layer 1 in the exterior material for electrical storage devices of the present disclosure include a configuration in which a polyethylene terephthalate film (preferably about 8 to 20 μm in thickness) on the outermost layer side and a nylon film (preferably about 8 to 20 μm in thickness) are bonded to each other by an adhesive agent layer (preferably about 2 to 5 μm in thickness) formed of an adhesive exemplified for the adhesive agent layer 2 described later. In the configuration, it is preferable that the nylon film has the above-described heat shrinkage ratio or moisture heat shrinkage ratio. The particularly preferred configuration of the base material layer 1 also include a configuration in which the base material layer includes a single nylon fill layer (preferably 10 to 30 μm, more preferably 20 to 30 μm in thickness).

### [Adhesive Agent Layer 2]

In the exterior material for electrical storage devices according to the present disclosure, the adhesive agent layer 2 is a layer provided between the base material layer 1 and the barrier layer 3 for the purpose of enhancing bondability between these layers.

The exterior material for electrical storage devices according to the present disclosure is cold-moldable, with the adhesive agent layer 2 having moisture and heat resistance. The phrase “the adhesive agent layer 2 has moisture and heat resistance” specifically means having moisture and heat resistance preferably in a saturated water vapor environment at a temperature of 120° C. More specifically, when the method for evaluation of moisture and heat resistance (the test sample is left standing in an autoclave for 10 hours, or even for 12 hours) is used to examine delamination between the base material layer 1 and the barrier layer 3 in the exterior material 10 for electrical storage devices after cold molding, the number of test samples undergoing the delamination, among a total of 12 samples of the exterior material for electrical storage devices, is preferably 4 or less, more preferably 3 or less, still more preferably 2 or less, particularly preferably 0.

From the viewpoint of suitably improving the moldability and the moisture and heat resistance of the exterior material for electrical storage devices according to the present disclosure, the glass transition temperature of the adhesive agent layer 2 is preferably 40° C. or higher, more preferably 80° C. or higher, still more preferably 100° C. or higher, even more preferably 111° C. or higher. From the same viewpoint, the glass transition temperature of the adhesive agent layer 2 is preferably 150° C. or lower, more preferably 145° C. or lower, still more preferably 139° C. or lower, even more preferably 135° C. or lower. The glass transition temperature of the adhesive agent layer 2 is preferably in the range of about 40 to 150° C., about 40 to 145° C., about 40 to 139° C., about 40 to 135° C., about 80 to 150° C., about 80 to 145° C., about 80 to 139° C., about 80 to 135° C., about 100 to 150° C., about 100 to 145° C., about 100 to 139° C., about 100 to 135° C., about 111 to 150° C., about 111 to 145° C., about 111 to 139° C., or about 111 to 135° C. The method for measuring the glass transition temperature of the adhesive agent layer 2 is as follows.

### <Method for Measuring Glass Transition Temperature>

The glass transition temperature is measured with a differential scanning calorimeter (for example, DSC, Differential Scanning calorimeter Q 200 manufactured by TA Instruments). Specifically, in accordance with the procedure in JIS K 7121: 2012 (Testing Methods for Transition Temperatures of Plastics (Amendment 1 to JIS K 7121: 1987)), measurement is performed by differential scanning calorimetry (DSC). An adhesive agent layer is held at 30° C. for 10 minutes, and then heated from 30° C. to 200° C. at a temperature rise rate of 10° C./min, and a temperature at an intersection of a straight line obtained by extending a baseline on the low temperature side to the high temperature side and a tangent line drawn at a point where the gradient of the curve of a portion in which the glass transition changes stepwise is maximized is determined, and taken as a glass transition temperature. An adhesive to be used for the adhesive agent layer 2 of the exterior material for electrical storage devices is applied onto a polyethylene terephthalate (PET) film (3 μm), and subjected to aging treatment to obtain the adhesive agent layer to be measured.

The adhesive agent layer 2 is formed from an adhesive capable of bonding the base material layer 1 and the barrier layer 3. The adhesive may be any of a chemical reaction type, a solvent volatilization type, a heat melting type, a heat pressing type, and the like as long as it can form an adhesive agent layer having moisture and heat resistance. The adhesive agent may be a two-liquid curable adhesive (two-liquid adhesive), a one-liquid curable adhesive (one-liquid adhesive), or a resin that does not involve curing reaction. The adhesive agent layer 2 may be a single layer or a multi-layer.

Specific examples of the adhesive component contained in the adhesive include polyester such as polyethylene terephthalate, polybutylene terephthalate, polyethylene naphthalate, polybutylene naphthalate, polyethylene isophthalate and copolyester; polyether; polyurethane; epoxy resins; phenol resins; polyamides such as nylon 6, nylon 66, nylon 12 and copolymerized polyamide; polyolefin-based resins such as polyolefins, cyclic polyolefins, acid-modified polyolefins and acid-modified cyclic polyolefins; cellulose; (meth)acrylic resins; polyimide; polycarbonate; amino resins such as urea resins and melamine resins; rubbers such as chloroprene rubber, nitrile rubber and styrene-butadiene rubber; and silicone resins. These adhesive components may be used alone, or may be used in combination of two or more thereof. Of these adhesive components, polyurethane-based adhesives are preferable. In addition, the adhesive strength of these resins used as adhesive components can be increased by using an appropriate curing agent in combination. As the curing agent, appropriate one is selected from polyisocyanate, a polyfunctional epoxy resin, an oxazoline group-containing polymer, a polyamine resin, an acid anhydride and the like according to the functional group of the adhesive component.

Examples of the polyurethane adhesive include polyurethane adhesives containing a first agent containing a polyol compound and a second agent containing an isocyanate compound. The polyurethane adhesive is preferably a two-liquid curable polyurethane adhesive having polyol such as polyester polyol, polyether polyol or acrylic polyol as a first agent, and aromatic or aliphatic polyisocyanate as a second agent. Examples of the polyurethane adhesive include polyurethane adhesives containing an isocyanate compound and a polyurethane compound obtained by reacting a polyol compound with an isocyanate compound in advance. Examples of the polyurethane adhesive include polyurethane adhesives containing a polyol compound and a polyurethane compound obtained by reacting a polyol compound with an isocyanate compound in advance. Examples of the polyurethane adhesive include polyurethane adhesives obtained by reacting a polyol compound with an isocyanate compound to form a polyurethane compound in advance, and reacting the polyurethane compound with moisture in the air or the like. Preferably, polyester polyol having a hydroxyl group in the side chain in addition to a hydroxyl group at the end of the repeating unit is used as the polyol compound. Examples of the curing agent include aliphatic, alicyclic, aromatic and araliphatic isocyanate-based compounds. Examples of the isocyanate-based compound include hexamethylene diisocyanate (HDI), xylylene diisocyanate (XDI), isophorone diisocyanate (IPDI), hydrogenated XDI (H6XDI), hydrogenated MDI (H 12 MDI), tolylene diisocyanate (TDI), diphenylmethane diisocyanate (MDI) and naphthalene diisocyanate (NDI). Examples of the isocyanate-based compound also include polyfunctional isocyanate-modified products of one or more of these diisocyanates can be mentioned. It is also possible to use a multimer (e.g. a trimer) as the polyisocyanate compound. Examples of the multimer include adducts, biurets, and nurates. Since the adhesive agent layer 2 is formed of a polyurethane adhesive, excellent electrolytic solution resistance is imparted to the exterior material for electrical storage devices, so that peeling of the base material layer 1 is suppressed even if the electrolytic solution is deposited on the side surface.

When the adhesive agent layer 2 is formed of a cured product of a two-liquid polyurethane adhesive, it is preferable that the glass transition temperature of the adhesive agent layer 2 satisfies the above-described glass transition temperature of the adhesive agent layer 2. That is, the glass transition temperature of the adhesive agent layer 2 formed of a cured product of a two-liquid polyurethane adhesive is preferably 40° C. or higher, more preferably 80° C. or higher, still more preferably 100° C. or higher, even more preferably 111° C. or higher. From the same viewpoint, the glass transition temperature of the adhesive agent layer 2 is preferably 150° C. or lower, more preferably 145° C. or lower, still more preferably 139° C. or lower, even more preferably 135° C. or lower. The glass transition temperature of the adhesive agent layer 2 is preferably in the range of about 40 to 150° C., about 40 to 145° C., about 40 to 139° C., about 40 to 135° C., about 80 to 150° C., about 80 to 145° C., about 80 to 139° C., about 80 to 135° C., about 100 to 150° C., about 100 to 145° C., about 100 to 139° C., about 100 to 135° C., about 111 to 150° C., about 111 to 145° C., about 111 to 139° C., or about 111 to 135° C.

In the exterior material for electrical storage devices according to the present disclosure, the adhesive for forming the adhesive agent layer 2 is preferably a two-liquid polyurethane adhesive. For ensuring that the two-liquid polyurethane adhesive is cold-moldable after curing and exhibits high moisture and heat resistance, the two-liquid polyurethane adhesive is designed so as to suppress hydrolysis of the polyurethane after curing and obtain a chemical structure with high flexibility. For example, for suppressing hydrolysis of the polyurethane, a compound containing a substituent which increases the cohesive force after curing and reacts with an acid, such as a carbodiimide group or an epoxy group, is added. For enhancing the flexibility of the polyurethane, for example, the ratio of the soft segment and the hard segment contained in the polyol compound is adjusted. When the adhesive agent layer 2 is formed of a cured product of a two-liquid polyurethane adhesive, it is preferable that the polyol compound forming the adhesive agent layer 2 contains another basic acid component and a polyhydric alcohol component, and the other basic acid component contains a soft segment and a hard segment. Examples of the soft segment include isophthalic acid and derivatives thereof, and examples of the hard segment include terephthalic acid and derivatives thereof. For enhancing the flexibility of the adhesive agent layer 2, for example, the mass ratio of the soft segment (e.g. isophthalic acid and derivatives thereof) and the hard segment (e.g. terephthalic acid and derivatives thereof) (soft segment:hard segment) is preferably about 35:65 to 90:10, more preferably about 40:60 to 85:15. For enhancing the moisture and heat resistance of the polyurethane after curing, it is desirable that the amount of a catalyst residue contained in the two-liquid polyurethane adhesive be reduced to decrease the hydrolysis rate of the polyurethane. Further, it is preferable to adjust the glass transition temperature of the two-liquid polyurethane adhesive after curing.

Other components may be added to the adhesive agent layer 2 as long as bondability moldability and moisture and heat resistance are not inhibited, and the adhesive agent layer 2 may contain a colorant, a thermoplastic elastomer, a tackifier, a filler, and the like. When the adhesive agent layer 2 contains a colorant, the exterior material for electrical storage devices can be colored. As the colorant, known colorants such as pigments and dyes can be used. The colorants may be used alone, or may be used in combination of two or more thereof.

The type of pigment is not particularly limited as long as the bondability of the adhesive agent layer 2 is not impaired. Examples of the organic pigment include azo-based pigments, phthalocyanine-based pigments, quinacridone-based pigments, anthraquinone-based pigments, dioxazine-based pigments, indigothioindigo-based pigments, perinone-perylene-based pigments, isoindolenine-based pigments and benzimidazolone-based pigments. Examples of the inorganic pigment include carbon black-based pigments, titanium oxide-based pigments, cadmium-based pigments, lead-based pigments, chromium-based pigments and iron-based pigments, and also fine powder of mica (mica) and fish scale foil.

Of the colorants, carbon black is preferable for the purpose of, for example, blackening the appearance of the exterior material for electrical storage devices.

The average particle diameter of the pigment is not particularly limited, and is, for example, about 0.05 to 5 μm, preferably about 0.08 to 2 μm. The average particle size of the pigment is a median diameter measured by a laser diffraction/scattering particle size distribution measuring apparatus.

The content of the pigment in the adhesive agent layer 2 is not particularly limited as long as the exterior material for electrical storage devices is colored, and the content is, for example, about 5 to 60 mass %, preferably 10 to 40 mass %.

The thickness of the adhesive agent layer 2 is not particularly limited as long as the base material layer 1 and the barrier layer 3 can be bonded to each other, and the thickness is, for example, about 1 μm or more, or about 2 μm or more. The thickness of the adhesive agent layer 2 is, for example, about 10 μm or less, or about 5 μm or less. The thickness of the adhesive agent layer 2 is preferably in the range of about 1 to 10 μm, about 1 to 5 μm, about 2 to 10 μm, or about 2 to 5 μm.

### [Colored Layer]

The colored layer is a layer provided between the base material layer 1 and the barrier layer 3 if necessary (not shown). When the adhesive agent layer 2 is present, the colored layer may be provided between the base material layer 1 and the adhesive agent layer 2 or between the adhesive agent layer 2 and the barrier layer 3. The colored layer may be provided outside the base material layer 1. By providing the colored layer, the exterior material for electrical storage devices can be colored.

The colored layer can be formed by, for example, applying an ink containing a colorant to the surface of the base material layer 1, or the surface of the barrier layer 3. As the colorant, known colorants such as pigments and dyes can be used. The colorants may be used alone, or may be used in combination of two or more thereof.

Specific examples of the colorant contained in the colored layer include the same colorants as those exemplified in the section [Adhesive Agent Layer 2].

### [Barrier Layer 3]

In the exterior material for electrical storage devices, the barrier layer 3 is a layer which suppresses at least ingress of moisture.

Examples of the barrier layer 3 include metal foils, deposited films and resin layers having a barrier property. Examples of the deposited film include metal deposited films, inorganic oxide deposited films and carbon-containing inorganic oxide deposited films, and examples of the resin layer include those of polyvinylidene chloride, fluorine-containing resins such as polymers containing chlorotrifluoroethylene (CTFE) as a main component, polymers containing tetrafluoroethylene (TFE) as a main component, polymers having a fluoroalkyl group, and polymers containing a fluoroalkyl unit as a main component, and ethylene vinyl alcohol copolymers. Examples of the barrier layer 3 include resin films provided with at least one of these deposited films and resin layers. A plurality of barrier layers 3 may be provided. Preferably, the barrier layer 3 contains a layer formed of a metal material. Specific examples of the metal material forming the barrier layer 3 include aluminum alloys, stainless steel, titanium steel and steel sheets. When the metal material is used as a metal foil, it is preferable that the metal material includes at least one of an aluminum alloy foil and a stainless steel foil.

The aluminum alloy is more preferably a soft aluminum alloy foil formed of, for example, an annealed aluminum alloy from the viewpoint of improving the moldability of the exterior material for electrical storage devices, and is preferably an aluminum alloy foil containing iron from the viewpoint of further improving the moldability. In the aluminum alloy foil containing iron (100 mass %), the content of iron is preferably 0.1 to 9.0 mass %, more preferably 0.5 to 2.0 mass %. When the content of iron is 0.1 mass % or more, it is possible to obtain an exterior material for electrical storage devices which has more excellent moldability. When the content of iron is 9.0 mass % or less, it is possible to obtain an exterior material for electrical storage devices which is more excellent in flexibility. Examples of the soft aluminum alloy foil include aluminum alloy foils having a composition specified in JIS H4160: 1994 A8021H-O, JIS H4160: 1994 A8079H-O, JIS H4000: 2014 A8021P-O, or JIS H4000: 2014 A8079P-O. If necessary, silicon, magnesium, copper, manganese or the like may be added. Softening can be performed by annealing or the like.

Examples of the stainless steel foil include austenitic stainless steel foils, ferritic stainless steel foils, austenitic/ferritic stainless steel foils, martensitic stainless steel foils and precipitation-hardened stainless steel foils. From the viewpoint of providing an exterior material for electrical storage devices which is further excellent in moldability, it is preferable that the stainless steel foil is formed of austenitic stainless steel.

Specific examples of the austenite-based stainless steel foil include SUS 304 stainless steel, SUS 301 stainless steel and SUS 316L stainless steel, and of these, SUS 304 stainless steel is especially preferable.

When the barrier layer 3 is a metal foil, the barrier layer 3 may perform a function as a barrier layer suppressing at least ingress of moisture, and has a thickness of, for example, about 9 to 200 μm. The thickness of the barrier layer 3 is preferably about 85 μm or less, more preferably about 50 μm or less, still more preferably about 40 μm or less, particularly preferably about 35 μm or less. The thickness of the barrier layer 3 is preferably about 10 μm or more, more preferably about 20 μm or more, still more preferably about 25 μm or more. The total thickness of the barrier layer 3 is preferably in the range of about 10 to 85 μm, about 10 to 50 μm, about 10 to 40 μm, about 10 to 35 μm, about 20 to 85 μm, about 20 to 50 μm, about 20 to 40 μm, about 20 to 35 μm, about 25 to 85 μm, about 25 to 50 μm, about 25 to 40 μm, or about 25 to 35 μm. When the barrier layer 3 is formed of an aluminum alloy foil, the thickness thereof is especially preferably in above-described range. In particular, when the barrier layer 3 includes a stainless steel foil, the thickness of the stainless steel foil is preferably about 60 μm or less, more preferably about 50 μm or less, still more preferably about 40 μm or less, even more preferably about 30 μm or less, particularly preferably about 25 μm or less. The thickness of the stainless steel foil is preferably about 10 μm or more, more preferably about 15 μm or more. The thickness of the stainless steel foil is preferably in the range of about 10 to 60 μm, about 10 to 50 μm, about 10 to 40 μm, about 10 to 30 μm, about 10 to 25 μm, about 15 to 60 μm, about 15 to 50 μm, about 15 to 40 μm, about 15 to 30 μm, or about 15 to 25 μm.

When the barrier layer 3 is a metal foil, it is preferable that a corrosion-resistant film is provided at least on a surface on a side opposite to the base material layer for preventing dissolution and corrosion. The barrier layer 3 may include a corrosion-resistant film on each of both surfaces. Here, the corrosion-resistant film refers to a thin film obtained by subjecting the surface of the barrier layer to, for example, hydrothermal denaturation treatment such as boehmite treatment, chemical conversion treatment, anodization treatment, plating treatment with nickel, chromium or the like, or corrosion prevention treatment by applying a coating agent to impart corrosion resistance (e.g. acid resistance and alkali resistance) to the barrier layer. Specifically, the corrosion-resistant film means a film which improves the acid resistance of the barrier layer (acid-resistant film), a film which improves the alkali resistance of the barrier layer (alkali-resistant film), or the like. One of treatments for forming the corrosion-resistant film may be performed, or two or more thereof may be performed in combination. In addition, not only one layer but also multiple layers can be formed. Further, of these treatments, the hydrothermal denaturation treatment and the anodization treatment are treatments in which the surface of the metal foil is dissolved with a treatment agent to form a metal compound excellent in corrosion resistance. The definition of the chemical conversion treatment may include these treatments. When the barrier layer 3 is provided with the corrosion-resistant film, the barrier layer 3 is regarded as including the corrosion-resistant film.

The corrosion-resistant film exhibits the effects of preventing delamination between the barrier layer (e.g. an aluminum alloy foil) and the base material layer during molding of the exterior material for electrical storage devices; preventing dissolution and corrosion of the surface of the barrier layer, particularly dissolution and corrosion of aluminum oxide present on the surface of the barrier layer when the barrier layer is an aluminum alloy foil, by hydrogen fluoride generated by reaction of an electrolyte with moisture; improving the bondability (wettability) of the surface of the barrier layer; preventing delamination between the base material layer and the barrier layer during heat-sealing; and preventing delamination between the base material layer and the barrier layer during molding.

Various corrosion-resistant films formed by chemical conversion treatment are known, and examples thereof include mainly corrosion-resistant films containing at least one of a phosphate, a chromate, a fluoride, a triazine thiol compound, and a rare earth oxide. Examples of the chemical conversion treatment using a phosphate or a chromate include chromic acid chromate treatment, phosphoric acid chromate treatment, phosphoric acid-chromate treatment and chromate treatment, and examples of the chromium compound used in these treatments include chromium nitrate, chromium fluoride, chromium sulfate, chromium acetate, chromium oxalate, chromium biphosphate, acetylacetate chromate, chromium chloride and chromium potassium sulfate. Examples of the phosphorus compound used in these treatments include sodium phosphate, potassium phosphate, ammonium phosphate and polyphosphoric acid. Examples of the chromate treatment include etching chromate treatment, electrolytic chromate treatment and coating-type chromate treatment, and coating-type chromate treatment is preferable. This coating-type chromate treatment is treatment in which at least a surface of the barrier layer (e.g. an aluminum alloy foil) on the inner layer side is first degreased by a well-known treatment method such as an alkali immersion method, an electrolytic cleaning method, an acid cleaning method, an electrolytic acid cleaning method or an acid activation method, and a treatment solution containing a metal phosphate such as Cr (chromium) phosphate, Ti (titanium) phosphate, Zr (zirconium) phosphate or Zn (zinc) phosphate or a mixture of these metal salts as a main component, a treatment solution containing any of non-metal salts of phosphoric acid and a mixture of these non-metal salts as a main component, or a treatment solution formed of a mixture of any of these salts and a synthetic resin or the like is then applied to the degreased surface by a well-known coating method such as a roll coating method, a gravure printing method or an immersion method, and dried. As the treatment liquid, for example, various solvents such as water, an alcohol-based solvent, a hydrocarbon-based solvent, a ketone-based solvent, an ester-based solvent, and an ether-based solvent can be used, and water is preferable. Examples of the resin component used here include polymers such as phenol-based resins and acryl-based resins, and examples of the treatment include chromate treatment using an aminated phenol polymer having any of repeating units represented by the following general formulae (1) to (4). In the aminated phenol polymer, the repeating units represented by the following general formulae (1) to (4) may be contained alone, or may be contained in combination of two or more thereof. The acryl-based resin is preferably polyacrylic acid, an acrylic acid-methacrylic acid ester copolymer, an acrylic acid-maleic acid copolymer, an acrylic acid-styrene copolymer, or a derivative thereof such as a sodium salt, an ammonium salt or an amine salt thereof. In particular, a derivative of polyacrylic acid such as an ammonium salt, a sodium salt or an amine salt of polyacrylic acid is preferable. In the present disclosure, the polyacrylic acid means a polymer of acrylic acid. The acryl-based resin is also preferably a copolymer of acrylic acid and dicarboxylic acid or dicarboxylic anhydride, and is also preferably an ammonium salt, a sodium salt or an amine salt of a copolymer of acrylic acid and dicarboxylic acid or dicarboxylic anhydride. The acryl-based resins may be used alone, or may be used in combination of two or more thereof.

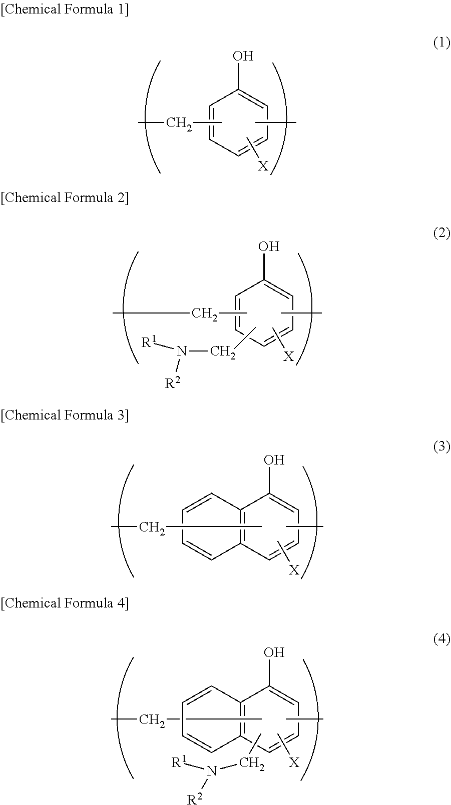

In the general formulae (1) to (4), X represents a hydrogen atom, a hydroxy group, an alkyl group, a hydroxyalkyl group, an allyl group, or a benzyl group. R¹ and R² are the same or different, and each represents a hydroxy group, an alkyl group, or a hydroxyalkyl group. In the general formulae (1) to (4), examples of the alkyl group represented by X, R¹ and R² include linear or branched alkyl groups with a carbon number of 1 to 4, such as a methyl group, an ethyl group, an n-propyl group, an isopropyl group, an n-butyl group, an isobutyl group, and a tert-butyl group. Examples of the hydroxyalkyl group represented by X, R¹ and R² include linear or branched alkyl groups with a carbon number of 1 to 4, which is substituted with one hydroxy group, such as a hydroxymethyl group, a 1-hydroxyethyl group, a 2-hydroxyethyl group, a 1-hydroxypropyl group, a 2-hydroxypropyl group, a 3-hydroxypropyl group, a 1-hydroxybutyl group, a 2-hydroxybutyl group, a 3-hydroxybutyl group, and a 4-hydroxybutyl group. In the general formulae (1) to (4), the alkyl group and the hydroxyalkyl group represented by X, R¹ and R² may be the same or different. In the general formulae (1) to (4), X is preferably a hydrogen atom, a hydroxy group or a hydroxyalkyl group. A number average molecular weight of the aminated phenol polymer having repeating units represented by the general formulae (1) to (4) is preferably about 500 to 1,000,000, and more preferably about 1,000 to 20,000, for example. The aminated phenol polymer is produced by, for example, performing polycondensation of a phenol compound or a naphthol compound with formaldehyde to prepare a polymer including repeating units represented by the general formula (1) or the general formula (3), and then introducing a functional group (—CH2NR¹R²) into the obtained polymer using formaldehyde and an amine (R¹R²NH). The aminated phenol polymers are used alone, or used in combination of two or more thereof.

Other examples of the corrosion-resistant film include thin films formed by corrosion prevention treatment of coating type in which a coating agent containing at least one selected from the group consisting of a rare earth element oxide sol, an anionic polymer and a cationic polymer is applied. The coating agent may further contain phosphoric acid or a phosphate, and a crosslinker for crosslinking the polymer. In the rare earth element oxide sol, fine particles of a rare earth element oxide (e.g. particles having an average particle diameter of 100 nm or less) are dispersed in a liquid dispersion medium. Examples of the rare earth element oxide include cerium oxide, yttrium oxide, neodymium oxide and lanthanum oxide, and cerium oxide is preferable from the viewpoint of further improving adhesion. The rare earth element oxides contained in the corrosion-resistant film can be used alone, or used in combination of two or more thereof. As the liquid dispersion medium for the rare earth element oxide, for example, various solvents such as water, an alcohol-based solvent, a hydrocarbon-based solvent, a ketone-based solvent, an ester-based solvent, and an ether-based solvent can be used, and water is preferable. For example, the cationic polymer is preferably polyethyleneimine, an ion polymer complex formed of a polymer having polyethyleneimine and a carboxylic acid, primary amine-grafted acrylic resins obtained by graft-polymerizing a primary amine with an acrylic main backbone, polyallylamine or a derivative thereof, or aminated phenol. The anionic polymer is preferably poly (meth)acrylic acid or a salt thereof, or a copolymer containing (meth)acrylic acid or a salt thereof as a main component. The crosslinker is preferably at least one selected from the group consisting of a silane coupling agent and a compound having any of functional groups including an isocyanate group, a glycidyl group, a carboxyl group and an oxazoline group. In addition, the phosphoric acid or phosphate is preferably condensed phosphoric acid or a condensed phosphate.

Examples of the corrosion-resistant film include films formed by applying a dispersion of fine particles of a metal oxide such as aluminum oxide, titanium oxide, cerium oxide or tin oxide or barium sulfate in phosphoric acid to the surface of the barrier layer and performing baking treatment at 150° C. or higher.

The corrosion-resistant film may have a laminated structure in which at least one of a cationic polymer and an anionic polymer is further laminated if necessary. Examples of the cationic polymer and the anionic polymer include those described above.

The composition of the corrosion-resistant film can be analyzed by, for example, time-of-flight secondary ion mass spectrometry.

The amount of the corrosion-resistant film to be formed on the surface of the barrier layer 3 in the chemical conversion treatment is not particularly limited, but for example when the coating-type chromate treatment is performed, and it is desirable that the chromic acid compound be contained in an amount of, for example, about 0.5 to 50 mg, preferably about 1.0 mg to 40 mg, in terms of chromium, the phosphorus compound be contained in an amount of, for example, about 0.5 to 50 mg, preferably about 1.0 to 40 mg, in terms of phosphorus, and the aminated phenol polymer be contained in an amount of, for example, about 1.0 to 200 mg, preferably about 5.0 mg to 150 mg, per 1 m² of the surface of the barrier layer 3.

The thickness of the corrosion-resistant film is not particularly limited, and is preferably about 1 nm to 20 μm, more preferably about 1 nm to 100 nm, still more preferably about 1 nm to 50 nm from the viewpoint of the cohesive force of the film and the adhesive strength with the barrier layer and the heat-sealable resin layer. The thickness of the corrosion-resistant film can be measured by observation with a transmission electron microscope or a combination of observation with a transmission electron microscope and energy dispersive X-ray spectroscopy or electron beam energy loss spectroscopy. By analyzing the composition of the corrosion-resistant film using time-of-flight secondary ion mass spectrometry, peaks derived from secondary ions from, for example, Ce, P and O (e.g. at least one of Ce₂PO₄⁺, CePO₄⁻ and the like) and secondary ions from, for example, Cr, P and O (e.g. at least one of CrPO₂⁺, CrPO₄⁻ and the like) are detected.

The chemical conversion treatment is performed in the following manner: a solution containing a compound to be used for formation of a corrosion-resistant film is applied to the surface of the barrier layer by a bar coating method, a roll coating method, a gravure coating method, an immersion method or the like, and heating is then performed so that the temperature of the barrier layer is about 70 to about 200° C. The barrier layer may be subjected to a degreasing treatment by an alkali immersion method, an electrolytic cleaning method, an acid cleaning method, an electrolytic acid cleaning method or the like before the barrier layer is subjected to a chemical conversion treatment. When a degreasing treatment is performed as described above, the chemical conversion treatment of the surface of the barrier layer can be further efficiently performed. When an acid degreasing agent with a fluorine-containing compound dissolved in an inorganic acid is used for degreasing treatment, not only a metal foil degreasing effect can be obtained but also a metal fluoride can be formed as a passive state, and in this case, only degreasing treatment may be performed.

### [Heat-Sealable Resin Layer 4]

In the exterior material for electrical storage devices according to the present disclosure, the heat-sealable resin layer 4 is a layer (sealant layer) which corresponds to an innermost layer and performs a function of hermetically sealing the electrical storage device element by heat-sealing the heat-sealable resin layer during construction of the electrical storage device.

The resin forming the heat-sealable resin layer 4 is not particularly limited as long as it can be heat-sealed, a resin containing a polyolefin backbone such as a polyolefin or an acid-modified polyolefin is preferable. The resin forming the heat-sealable resin layer 4 can be confirmed to contain a polyolefin backbone by an analysis method such as infrared spectroscopy or gas chromatography-mass spectrometry. In addition, it is preferable that a peak derived from maleic anhydride is detected when the resin forming the heat-sealable resin layer 4 is analyzed by infrared spectroscopy. For example, when a maleic anhydride-modified polyolefin is measured by infrared spectroscopy, peaks derived from maleic anhydride are detected near wavenumbers of 1760 cm⁻¹ and 1780 cm⁻¹. When the heat-sealable resin layer 4 is a layer formed of a maleic anhydride-modified polyolefin, a peak derived from maleic anhydride is detected when measurement is performed by infrared spectroscopy. However, if the degree of acid modification is low, the peaks may be too small to be detected. In that case, the peaks can be analyzed by nuclear magnetic resonance spectroscopy.

Specific examples of the polyolefin include polyethylenes such as low-density polyethylene, medium-density polyethylene, high-density polyethylene and linear low-density polyethylene; ethylene-α-olefin copolymers; polypropylene such as homopolypropylene, block copolymers of polypropylene (e.g., block copolymers of propylene and ethylene) and random copolymers of polypropylene (e.g., random copolymers of propylene and ethylene); propylene-α-olefin copolymers; and terpolymers of ethylene-butene-propylene. Of these, polypropylene is preferable. The polyolefin resin in the case of a copolymer may be a block copolymer or a random copolymer. These polyolefin-based resins may be used alone, or may be used in combination of two or more thereof.

The polyolefin may be a cyclic polyolefin. The cyclic polyolefin is a copolymer of an olefin and a cyclic monomer, and examples of the olefin as a constituent monomer of the cyclic polyolefin include ethylene, propylene, 4-methyl-1-pentene, styrene, butadiene and isoprene. Examples of the cyclic monomer as a constituent monomer of the cyclic polyolefin include cyclic alkenes such as norbornene; cyclic dienes such as cyclopentadiene, dicyclopentadiene, cyclohexadiene and norbornadiene. Among these polyolefins, cyclic alkenes are preferable, and norbornene is more preferable.

The acid-modified polyolefin is a polymer with the polyolefin modified by subjecting the polyolefin to block polymerization or graft polymerization with an acid component. As the polyolefin to be acid-modified, the above-mentioned polyolefins, copolymers obtained by copolymerizing polar molecules such as acrylic acid or methacrylic acid with the above-mentioned polyolefins, polymers such as crosslinked polyolefins, or the like can also be used. Examples of the acid component to be used for acid modification include carboxylic acids such as maleic acid, acrylic acid, itaconic acid, crotonic acid, maleic anhydride and itaconic anhydride, and anhydrides thereof.

The acid-modified polyolefin may be an acid-modified cyclic polyolefin. The acid-modified cyclic polyolefin is a polymer obtained by copolymerizing a part of monomers forming the cyclic polyolefin in place of an acid component, or block-polymerizing or graft-polymerizing an acid component with the cyclic polyolefin. The cyclic polyolefin to be modified with an acid is the same as described above. The acid component to be used for acid modification is the same as the acid component used for modification of the polyolefin.

Examples of preferred acid-modified polyolefins include polyolefins modified with a carboxylic acid or an anhydride thereof, polypropylene modified with a carboxylic acid or an anhydride thereof, maleic anhydride-modified polyolefins, and maleic anhydride-modified polypropylene.

The heat-sealable resin layer 4 may be formed from one resin alone, or may be formed from a blend polymer obtained by combining two or more resins. Further, the heat-sealable resin layer 4 may be composed of only one layer, or may be composed of two or more layers with the same resin component or different resin components.

The heat-sealable resin layer 4 may contain a slipping agent etc. if necessary. When the heat-sealable resin layer 4 contains a slipping agent, the moldability of the exterior material for electrical storage devices can be improved. The slipping agent is not particularly limited, and a known slipping agent can be used. The slipping agents may be used alone, or may be used in combination of two or more thereof.

The slipping agent is not particularly limited, and is preferably an amide-based slipping agent. Specific examples of the slipping agent include those exemplified for the base material layer 1. The slipping agents may be used alone, or may be used in combination of two or more thereof.

When a slipping agent is present on the surface of the first heat-sealable resin layer 4, the amount of the slipping agent present is not particularly limited, and is preferably about 10 to 50 mg/m², more preferably about 15 to 40 mg/m² from the viewpoint of improving the moldability of the exterior material for electrical storage devices.

The slipping agent present on the surface of the heat-sealable resin layer 4 may be one obtained by exuding the slipping agent contained in the resin forming the heat-sealable resin layer 4, or one obtained by applying a slipping agent to the surface of the heat-sealable resin layer 4.

The thickness of the heat-sealable resin layer 4 is not particularly limited as long as the heat-sealable resin layers are heat-sealed to each other to perform a function of sealing the electrical storage device element, and the thickness is, for example, about 100 μm or less, preferably about 85 μm or less, more preferably about 15 to 85 μm. For example, when the thickness of the adhesive layer 5 described later is 10 μm or more, the thickness of the heat-sealable resin layer 4 is preferably about 85 μm or less, more preferably about 15 to 45 μm. For example, when the thickness of the adhesive layer 5 described later is less than 10 μm or the adhesive layer 5 is not provided, the thickness of the heat-sealable resin layer 4 is preferably about 20 μm or more, more preferably about 35 to 85 μm.

### [Adhesive Layer 5]

In the exterior material for electrical storage devices according to the present disclosure, the adhesive layer 5 is a layer provided between the barrier layer 3 (or corrosion-resistant film) and the heat-sealable resin layer 4 if necessary for firmly bonding these layers to each other.

The adhesive layer 5 is formed from a resin capable of bonding the barrier layer 3 and the heat-sealable resin layer 4 to each other. The resin to be used for forming the adhesive layer 5 is, for example, the same as that of the adhesive exemplified for the adhesive agent layer 2. From the viewpoint of firmly bonding the adhesive layer 5 to the heat-sealable resin layer 4, it is preferable that the resin to be used for forming the adhesive layer 5 contains a polyolefin backbone. Examples thereof include the polyolefins and acid-modified polyolefins exemplified for the heat-sealable resin layer 4 described above. On the other hand, from the viewpoint of firmly bonding the barrier layer 3 and the adhesive layer 5 to each other, it is preferable that the adhesive layer 5 contains an acid-modified polyolefin. Examples of the acid modifying component include dicarboxylic acids such as maleic acid, itaconic acid, succinic acid and adipic acid, anhydrides thereof, acrylic acid, and methacrylic acid, and maleic anhydride is most preferable from the viewpoint of ease of modification, general-purpose property, and the like. From the viewpoint of the heat resistance of the exterior material for electrical storage devices, the olefin component is preferably a polypropylene-based resin, and it is most preferable that the adhesive layer 5 contains maleic anhydride-modified polypropylene.

The resin forming the adhesive layer 5 can be confirmed to contain a polyolefin backbone by an analysis method such as infrared spectroscopy, gas chromatography-mass spectrometry, and the analysis method is not particularly limited. The resin forming the adhesive layer 5 is confirmed to contain an acid-modified polyolefin, for example, when peaks derived from maleic anhydride are detected near wavenumbers of 1760 cm⁻¹ and 1780 cm⁻¹ when a maleic anhydride-modified polyolefin is measured by infrared spectroscopy. However, if the degree of acid modification is low, the peaks may be too small to be detected. In that case, the peaks can be analyzed by nuclear magnetic resonance spectroscopy.

Further, from the viewpoint of securing durability, such as heat resistance and content resistance and securing moldability, of the exterior material for electrical storage devices while reducing the thickness, the adhesive layer 5 is more preferably a cured product of a resin composition containing an acid-modified polyolefin and a curing agent. Preferred examples of the acid-modified polyolefin include those described above.

The adhesive layer 5 is preferably a cured product of a resin composition containing an acid-modified polyolefin and at least one selected from the group consisting of a compound having an isocyanate group, a compound having an oxazoline group, and a compound having an epoxy group, especially preferably a cured product of a resin composition containing an acid-modified polyolefin and at least one selected from the group consisting of a compound having an isocyanate group and a compound having an epoxy group. Preferably, the adhesive layer 5 preferably contains at least one selected from the group consisting of polyurethane, polyester and epoxy resin. More preferably, the adhesive layer 5 contains polyurethane and epoxy resin. As the polyester, for example, an ester resin produced by reaction of an epoxy group with a maleic anhydride group, or an amide ester resin produced by reaction of an oxazoline group with a maleic anhydride group is preferable. When an unreacted substance of a curing agent, such as a compound having an isocyanate group, a compound having an oxazoline group, or an epoxy resin remains in the adhesive layer 5, the presence of the unreacted substance can be confirmed by, for example, a method selected from infrared spectroscopy, Raman spectroscopy, time-of-flight secondary ion mass spectrometry (TOF-SIMS) and the like.

From the viewpoint of further improving adhesion between the barrier layer 3 and the adhesive layer 5, the adhesive layer 5 is preferably a cured product of a resin composition containing a curing agent having at least one selected from the group consisting of an oxygen atom, a heterocyclic ring, a C═N bond, and a C—O—C bond. Examples of the curing agent having a heterocyclic ring include curing agents having an oxazoline group, and curing agents having an epoxy group. Examples of the curing agent having a C═N bond include curing agents having an oxazoline group and curing agents having an isocyanate group. Examples of the curing agent having a C—O—C bond include curing agents having an oxazoline group, curing agents having an epoxy group. Whether the adhesive layer 5 is a cured product of a resin composition containing any of these curing agents can be confirmed by, for example, a method such as gas chromatography-mass spectrometry (GCMS), infrared spectroscopy (IR), time-of-flight secondary ion mass spectrometry (TOF-SIMS), or X-ray photoelectron spectroscopy (XPS).

The compound having an isocyanate group is not particularly limited, and is preferably a polyfunctional isocyanate compound from the viewpoint of effectively improving adhesion between the barrier layer 3 and the adhesive layer 5. The polyfunctional isocyanate compound is not particularly limited as long as it is a compound having two or more isocyanate groups. Specific examples of the polyfunctional isocyanate-based curing agent include pentane diisocyanate (PDI), isophorone diisocyanate (IPDI), hexamethylene diisocyanate (HDI), tolylene diisocyanate (TDI), diphenylmethane diisocyanate (MDI), polymerized or nurated products thereof, mixtures thereof, and copolymers of these compounds with other polymers. Examples thereof include adduct forms, biuret forms, and isocyanurate forms.

The content of the compound having an isocyanate group in the adhesive layer 5 is preferably in the range of 0.1 to 50 mass %, more preferably in the range of 0.5 to 40 mass % in the resin composition forming the adhesive layer 5. This enables effective improvement of adhesion between the barrier layer 3 and the adhesive layer 5.

The compound having an oxazoline group is not particularly limited as long as it is a compound having an oxazoline backbone. Specific examples of the compound having an oxazoline group include compounds having a polystyrene main chain and compounds having an acrylic main chain. Examples of the commercially available product include EPOCROS series manufactured by Nippon Shokubai Co., Ltd.

The proportion of the compound having an oxazoline group in the adhesive layer 5 is preferably in the range of 0.1 to 50 mass %, more preferably in the range of 0.5 to 40 mass % in the resin composition forming the adhesive layer 5. This enables effective improvement of adhesion between the barrier layer 3 and the adhesive layer 5.

Examples of the compound having an epoxy group include epoxy resins. The epoxy resin is not particularly limited as long as it is a resin capable of forming a crosslinked structure by epoxy groups existing in the molecule, and a known epoxy resin can be used. The weight average molecular weight of the epoxy resin is preferably about 50 to 2,000, more preferably about 100 to 1,000, still more preferably about 200 to 800. In the first present disclosure, the weight average molecular weight of the epoxy resin is a value obtained by performing measurement by gel permeation chromatography (GPC) under the condition of using polystyrene as a standard sample.

Specific examples of the epoxy resin include glycidyl ether derivatives of trimethylolpropane, bisphenol A diglycidyl ether, modified bisphenol A diglycidyl ether, bisphenol F-type glycidyl ether, novolak glycidyl ether, glycerin polyglycidyl ether and polyglycerin polyglycidyl ether. The epoxy resins may be used alone, or may be used in combination of two or more thereof.

The proportion of the epoxy resin in the adhesive layer 5 is preferably in the range of 0.1 to 50 mass %, more preferably in the range of 0.5 to 40 mass % in the resin composition forming the adhesive layer 5. This enables effective improvement of adhesion between the barrier layer 3 and the adhesive layer 5.

The polyurethane is not particularly limited, and a known polyurethane can be used. The adhesive layer 5 may be, for example, a cured product of two-liquid curable polyurethane.

The proportion of the polyurethane in the adhesive layer 5 is preferably in the range of 0.1 to 50 mass %, more preferably in the range of 0.5 to 40 mass % in the resin composition forming the adhesive layer 5. This enables effective improvement of adhesion between the barrier layer 3 and the adhesive layer 5 in an atmosphere including a component which induces corrosion of the barrier layer, such as an electrolytic solution.

When the adhesive layer 5 is a cured product of a resin composition containing at least one selected from the group consisting of a compound having an isocyanate group, a compound having an oxazoline group and an epoxy resin, and the acid-modified polyolefin, the acid-modified polyolefin functions as a main agent, and the compound having an isocyanate group, the compound having an oxazoline group, and the compound having an epoxy group each function as a curing agent.

The adhesive layer 5 may contain a modifier having a carbodiimide group.

The thickness of the adhesive layer 5 is preferably about 50 μm or less, about 40 μm or less, about 30 μm or less, about 20 μm or less, or about 5 μm or less. The thickness of the adhesive layer 5 is preferably about 0.1 μm or more, or about 0.5 μm or more. The thickness of the adhesive layer 5 is preferably in the range of about 0.1 to 50 μm, about 0.1 to 40 μm, about 0.1 to 30 μm, about 0.1 to 20 μm, about 0.1 to 5 μm, about 0.5 to 50 μm, about 0.5 to 40 μm, about 0.5 to 30 μm, about 0.5 to 20 μm, or about 0.5 to 5 μm. More specifically, the thickness is preferably about 1 to 10 μm, more preferably about 1 to 5 μm in the case of the adhesive exemplified for the adhesive agent layer 2 or a cured product of an acid-modified polyolefin with a curing agent. When any of the resins exemplified for the heat-sealable resin layer 4 is used, the thickness of the adhesive layer is preferably about 2 to 50 μm, more preferably about 10 to 40 μm. When the adhesive layer 5 is a cured product of a resin composition containing the adhesive exemplified for the adhesive agent layer 2 or an acid-modified polyolefin and a curing agent, the adhesive layer 5 can be formed by, for example, applying the resin composition and curing the resin composition by heating or the like. When the resin exemplified for the heat-sealable resin layer 4 is used, for example, extrusion molding of the heat-sealable resin layer 4 and the adhesive layer 5 can be performed.

### [Surface Coating Layer 6]

The exterior material for electrical storage devices according to the present disclosure may include a surface coating layer 6 on the base material layer 1 (on a side opposite to the barrier layer 3 from the base material layer 1) if necessary for the purpose of improving at least one of designability, electrolytic solution resistance, scratch resistance, moldability and the like. The surface coating layer 6 is a layer located on the outermost layer side of the exterior material for electrical storage devices when the power storage device is constructed using the exterior material for electrical storage devices.

The surface coating layer 6 can be formed from, for example, a resin such as polyvinylidene chloride, polyester, polyurethane, acrylic resin, or epoxy resin.

When the resin forming the surface coating layer 6 is a curable resin, the resin may be any of a one-liquid curable type and a two-liquid curable type, and is preferably a two-liquid curable type. Examples of the two-liquid curable resin include two-liquid curable polyurethane, two-liquid curable polyester and two-liquid curable epoxy resins. Of these, two-liquid curable polyurethane is preferable.

Examples of the two-liquid curable polyurethane include polyurethane which contains a first agent containing a polyol compound and a second agent containing an isocyanate compound. The polyurethane is preferably a two-liquid curable polyurethane adhesive having polyol such as polyester polyol, polyether polyol or acrylic polyol as a first agent, and aromatic or aliphatic polyisocyanate as a second agent. Examples of the polyurethane include polyurethane containing an isocyanate compound and a polyurethane compound obtained by reacting a polyol compound with an isocyanate compound in advance. Examples of the polyurethane include polyurethane containing a polyurethane compound and a polyurethane compound obtained by reacting a polyol compound with an isocyanate compound in advance. Examples of the polyurethane include polyurethane obtained by reacting a polyol compound with an isocyanate compound to form a polyurethane compound in advance, and reacting the polyurethane compound with moisture in the air or the like. Preferably, polyester polyol having a hydroxyl group in the side chain in addition to a hydroxyl group at the end of the repeating unit is used as the polyol compound. Examples of the second agent include aliphatic, alicyclic, aromatic and araliphatic isocyanate-based compounds. Examples of the isocyanate-based compound include hexamethylene diisocyanate (HDI), xylylene diisocyanate (XDI), isophorone diisocyanate (IPDI), hydrogenated XDI (H6XDI), hydrogenated MDI (H 12 MDI), tolylene diisocyanate (TDI), diphenylmethane diisocyanate (MDI) and naphthalene diisocyanate (NDI). Examples of the isocyanate-based compound also include polyfunctional isocyanate-modified products of one or more of these diisocyanates can be mentioned. It is also possible to use a multimer (e.g. a trimer) as the polyisocyanate compound. Examples of the multimer include adducts, biurets, and nurates. The aliphatic isocyanate-based compound is an isocyanate having an aliphatic group and having no aromatic ring, the alicyclic isocyanate-based compound is an isocyanate having an alicyclic hydrocarbon group, and the aromatic isocyanate-based compound is an isocyanate having an aromatic ring. Since the surface coating layer 6 is formed of polyurethane, excellent electrolytic solution resistance is imparted to the exterior material for electrical storage devices.

If necessary, the surface coating layer 6 may contain additives such as the slipping agent, an anti-blocking agent, a matting agent, a flame retardant, an antioxidant, a tackifier and an anti-static agent on at least one of the surface and the inside of the surface coating layer 6 according to the functionality and the like to be imparted to the surface coating layer 6 and the surface thereof. The additives are in the form of, for example, fine particles having an average particle diameter of about 0.5 nm to 5 μm. The average particle diameter of the additives is a median diameter measured by a laser diffraction/scattering particle size distribution measuring apparatus.

The additives may be either inorganic substances or organic substances. The shape of the additive is not particularly limited, and examples thereof include a spherical shape, a fibrous shape, a plate shape, an amorphous shape and a scaly shape.

Specific examples of the additives include talc, silica, graphite, kaolin, montmorillonite, mica, hydrotalcite, silica gel, zeolite, aluminum hydroxide, magnesium hydroxide, zinc oxide, magnesium oxide, aluminum oxide, neodymium oxide, antimony oxide, titanium oxide, cerium oxide, calcium sulfate, barium sulfate, calcium carbonate, calcium silicate, lithium carbonate, calcium benzoate, calcium oxalate, magnesium stearate, alumina, carbon black, carbon nanotubes, high-melting-point nylons, acrylate resins, crosslinked acryl, crosslinked styrene, crosslinked polyethylene, benzoguanamine, gold, aluminum, copper and nickel. The additives may be used alone, or may be used in combination of two or more thereof. Of these additives, silica, barium sulfate and titanium oxide are preferable from the viewpoint of dispersion stability, costs, and so on. The surface of the additive may be subjected to various kinds of surface treatments such as insulation treatment and dispersibility enhancing treatment.

The method for forming the surface coating layer 6 is not particularly limited, and examples thereof include a method in which a resin for forming the surface coating layer 6 is applied. When the additive is added to the surface coating layer 6, a resin mixed with the additive may be applied.

The thickness of the surface coating layer 6 is not particularly limited as long as the above-mentioned function as the surface coating layer 6 is performed, and it is, for example, about 0.5 to 10 preferably about 1 to 5

### 3. Method for Manufacturing Exterior Material for Electrical Storage Devices

The method for manufacturing an exterior material for electrical storage devices is not particularly limited as long as a laminate is obtained in which the layers of the exterior material for electrical storage devices according to the present invention are laminated. Examples thereof include a method including the step of laminating at least the base material layer 1, the adhesive agent layer 2, the barrier layer 3 and the heat-sealable resin layer 4 in this order. That is, the method for manufacturing an exterior material for electrical storage devices includes the step of laminating at least a base material layer, an adhesive agent layer, a barrier layer and a heat-sealable resin layer in this order to obtain a laminate, the adhesive agent layer having moisture and heat resistance, the laminate being cold-moldable.

An example of the method for manufacturing the exterior material for electrical storage devices of the present invention is as follows. First, a laminate including the base material layer 1, the adhesive agent layer 2 and the barrier layer 3 in this order (hereinafter, the laminate may be described as a “laminate A”) is formed. Specifically, the laminate A can be formed by a dry lamination method in which an adhesive to be used for formation of the adhesive agent layer 2 is applied onto the base material layer 1 or the barrier layer 3, the surface of which is subjected to a chemical conversion treatment if necessary, using a coating method such as a gravure coating method or a roll coating method, and dried, the barrier layer 3 or the base material layer 1 is then laminated, and the adhesive agent layer 2 is cured.

Then, the heat-sealable resin layer 4 is laminated on the barrier layer 3 of the laminate A. When the heat-sealable resin layer 4 is laminated directly on the barrier layer 3, the heat-sealable resin layer 4 may be laminated onto the barrier layer 3 of the laminate A by a method such as a thermal lamination method or an extrusion lamination method. When the adhesive layer 5 is provided between the barrier layer 3 and the heat-sealable resin layer 4, mention is made of, for example, (1) a method in which the adhesive layer 5 and the heat-sealable resin layer 4 are extruded to be laminated on the barrier layer 3 of the laminate A (extrusion lamination method or tandem lamination method); (2) a method in which the adhesive layer 5 and the heat-sealable resin layer 4 are laminated to form a laminate separately, and the laminate is laminated on the barrier layer 3 of the laminate A by a thermal lamination method, or a method in which a laminate with the adhesive layer 5 laminated on the barrier layer 3 of the laminate A is formed, and laminated to the heat-sealable resin layer 4 by a thermal lamination method; (3) a method in which the melted adhesive layer 5 is poured between the barrier layer 3 of the laminate A and the heat-sealable resin layer 4 formed in a sheet shape beforehand, and simultaneously the laminate A and the heat-sealable resin layer 4 are bonded together with the adhesive layer 5 interposed therebetween (sandwich lamination); and (4) an adhesive for forming the adhesive layer 5 is applied by solution coating and dried or baked to laminate the adhesive on the barrier layer 3 of the laminate A, and the heat-sealable resin layer 4 formed in a sheet shape in advance is laminated on the adhesive layer 5.

When the surface coating layer 6 is provided, the surface coating layer 6 is laminated on a surface of the base material layer 1 on a side opposite to the barrier layer 3. The surface coating layer 6 can be formed by, for example, coating a surface of the base material layer 1 with the resin that forms the surface coating layer 6. The order of the step of laminating the barrier layer 3 on a surface of the base material layer 1 and the step of laminating the surface coating layer 6 on a surface of the base material layer 1 is not particularly limited. For example, the surface coating layer 6 may be formed on a surface of the base material layer 1, followed by forming the barrier layer 3 on a surface of the base material layer 1 on a side opposite to the surface coating layer 6.

As described above, a laminate including the surface coating layer 6 provided if necessary, the base material layer 1, the adhesive agent layer 2, the barrier layer 3, the adhesive layer 5 provided if necessary, and the heat-sealable resin layer 4 in this order is formed, and the laminate may be further subjected to a heating treatment for strengthening the bondability of the adhesive agent layer 2 and the adhesive layer 5.

In the exterior material for electrical storage devices, the layers forming the laminate may be subjected to surface activation treatment such as corona treatment, blast treatment, oxidation treatment or ozone treatment if necessary to improve processing suitability. For example, by subjecting a surface of the base material layer 1, which is opposite to the barrier layer 3, to a corona treatment, the ink printability of the surface of the base material layer 1 can be improved.

### 4. Uses of Exterior Material for Electrical Storage Devices

The exterior material for electrical storage devices according to the present disclosure is used as a packaging for hermetically sealing and storing electrical storage device elements such as a positive electrode, a negative electrode and an electrolyte. That is, in a packaging formed of the exterior material for electrical storage devices of the present disclosure, an electrical storage device element including at least a positive electrode, a negative electrode and an electrolyte can be stored to obtain an electrical storage device.

Specifically, an electrical storage device element including at least a positive electrode, a negative electrode and an electrolyte is covered with the exterior material for electrical storage devices according to the present disclosure such that a flange portion (region where a heat-sealable resin layer is in contact with itself) can be formed on the periphery of the electrical storage device element while a metal terminal connected to each of the positive electrode and the negative electrode protrudes to the outside, and the heat-sealable resin layer at the flange portion is heat-sealed with itself, thereby providing an electrical storage device using the exterior material for electrical storage devices. When the electrical storage device element is stored in the packaging formed of the exterior material for electrical storage devices according to the present disclosure, the packaging is formed in such a manner that the heat-sealable resin portion of the exterior material for electrical storage devices according to the present disclosure is on the inner side (a surface contacting the electrical storage device element). The heat-sealable resin layers of two exterior materials for electrical storage devices may be superposed in such a manner as to face each other, followed by heat-sealing the peripheral edge portions of the superposed exterior materials for electrical storage devices to form a packaging. Alternatively, as in the example shown in FIG. 4, one exterior material for electrical storage devices may be folded over itself, followed by heat-sealing the peripheral edge portions to form a packaging. When the exterior material is folded over itself, a packaging may be formed by three-side sealing with the exterior material heat-sealed at sides other than the folding side as in the example shown in FIG. 4, or may be subjected to four-side sealing with the exterior material folded in such a manner that a flange portion can be formed. In the exterior material for electrical storage devices, a concave portion for housing an electrical storage device element may be formed by deep drawing molding or bulging molding. As in the example shown in FIG. 4, one exterior material for electrical storage devices may be provided with a concave portion while the other exterior material for electrical storage devices is not provided a concave portion, or the other exterior material for electrical storage devices may also be provided with a concave portion.

The exterior material for electrical storage devices according to the present disclosure can be suitably used for electrical storage devices such as batteries (including condensers, capacitors and the like.). The exterior material for electrical storage devices according to the present disclosure may be used for either primary batteries or secondary batteries, and is preferably used for secondary batteries. The type of a secondary battery to which the exterior material for electrical storage devices according to the present disclosure is applied is not particularly limited, and examples thereof include lithium ion batteries, lithium ion polymer batteries, solid-state batteries, lead storage batteries, nickel-hydrogen storage batteries, nickel-cadmium storage batteries, nickel-iron storage batteries, nickel-zinc storage batteries, silver oxide-zinc storage batteries, metal-air batteries, polyvalent cation batteries, condensers and capacitors. Of these secondary batteries, preferred subjects to which the exterior material for electrical storage devices according to the present disclosure is applied include lithium ion batteries and lithium ion polymer batteries.

### EXAMPLES

Hereinafter, the present disclosure will be described in detail by way of examples and comparative examples. However, the present disclosure is not limited to examples.

### <Manufacturing of Exterior Material for Electrical Storage Devices>

### Examples 1 to 4 and Comparative Examples 1 to 4

Exterior materials for electrical storage devices in Examples 1 to 4 and Comparative Examples 1 to 4 were manufactured in accordance with the following procedure. A base material layer and a barrier layer were laminated by a dry lamination method using the following two-liquid polyurethane adhesives A to D (see Table 2), and aging treatment was performed to product a laminate of a base material layer, an adhesive agent layer (thickness after curing: 3 μm) and a barrier layer.

The two-liquid polyurethane adhesives A to D used in the dry lamination method are as follows.

Adhesive A: Two-liquid polyurethane adhesive (glass transition temperature after curing: 134° C.) using a polyester polyol and an aromatic isocyanate-based compound, where the adhesive has moisture and heat resistance after curing.

Adhesive B: Two-liquid polyurethane adhesive using a polyester polyol and an aromatic isocyanate-based compound, where the adhesive is different from adhesive A, and has moisture and heat resistance after curing.

Adhesive C: Two-liquid polyurethane adhesive (glass transition temperature after curing: 163° C.) using a polyester polyol and an aliphatic isocyanate-based compound, where the adhesive has high moisture and heat resistance after curing, and is used for back sheets of solar cells.

Adhesive D: Two-liquid polyurethane adhesive (glass transition temperature after curing: 152° C.) using a polyester polyol and an aromatic isocyanate-based compound, where the adhesive has high heat resistance and moldability after curing, and is used for exterior material for in-vehicle electrical storage devices.

### <Method for Measuring Glass Transition Temperature>

The glass transition temperatures of adhesives A to D were measured with a differential scanning calorimeter (DSC, Differential Scanning calorimeter Q 200 manufactured by TA Instruments). Specifically, in accordance with the procedure in JIS K 7121: 2012 (Testing Methods for Transition Temperatures of Plastics (Amendment 1 to JIS K 7121: 1987)), measurement was performed by differential scanning calorimetry (DSC). A cured adhesive agent layer was held at 30° C. for 10 minutes, and then heated from 30° C. to 200° C. at a temperature rise rate of 10° C./min, and a temperature at an intersection of a straight line obtained by extending a baseline on the low temperature side to the high temperature side and a tangent line drawn at a point where the gradient of the curve of a portion in which the glass transition changes stepwise is maximized was determined, and taken as a glass transition temperature. An adhesive was applied onto a polyethylene terephthalate (PET) film (3 μm), and subjected to aging treatment (under the same conditions (temperature and time) as in the aging treatment in examples) to obtain the adhesive agent layer to be measured.

A polyethylene terephthalate (PET) film (thickness: 12 μm) and a stretched nylon (ONy) film (thickness: 15 μm) were used for the base material layer. As the stretched nylon film, three types of ONy films A, B and C (ONyA, ONyB and ONyC) having physical properties (thermal shrinkage ratio and moisture and heat shrinkage ratio) shown in Table 1 were used (see Tables 1 and 2). The PET film and the ONy film were bonded to each other by a dry lamination method using the above-described two-liquid polyurethane adhesive (thickness after drying: 3 see Table 2) to obtain a base material layer.

As the barrier layer, aluminum alloy foil A (JIS H 4160: 1994 A 8021 H-O (thickness 40 μm)) was used in Examples 1, 3 and 4 and Comparative Example 1 and 3, and aluminum alloy foil B (JIS H 4160: 1994 A 8079 H-O (thickness 40 μm)) was used in Example 2 and Comparative Example 4. Both surfaces of the aluminum alloy foil are subjected to chemical conversion treatment. The chemical conversion treatment of the aluminum alloy foil was performed by applying to both the surfaces of the aluminum alloy foil a treatment liquid including a phenol resin, a chromium fluoride compound and phosphoric acid using a roll coating method in such a manner that the application amount of chromium was 10 mg/m² (dry mass), and performing baking.

Maleic anhydride-modified polypropylene as an adhesive layer (thickness: 40 μm) and random polypropylene as a heat-sealable resin layer (thickness: 40 μm) were laminated onto the barrier layer of each of the obtained laminates of a base material layer, an adhesive agent layer (thickness after curing: 3 μm), a barrier layer to obtain an exterior material for electrical storage devices in which a base material layer (thickness: 30 μm including an adhesive agent layer between the PET film and the Ony film), an adhesive agent layer (3 μm), a barrier layer (40 μm), an adhesive layer (40 μm) and a heat-sealable resin layer (40 μm) are laminated in this order.

### Example 5 and Comparative Examples 5 and 6

Ony film D which is the same as the ONy film C used in Comparative Example 4 except for having a thickness of 25 μm (manufactured in the same manner except that the thickness was 25 μm) was used as a base material layer. An aluminum alloy foil B (JIS H4160: 1994A 8079 H-O (thickness: 40 μm)) was prepared as a barrier layer. A base material layer and a barrier layer were laminated by a dry lamination method using the above-described two-liquid polyurethane adhesives A, C and D (see Table 3), and aging treatment was performed to product a laminate of a base material layer, an adhesive agent layer (thickness after curing: 3 μm) and a barrier layer. Both surfaces of the aluminum alloy foil are subjected to chemical conversion treatment. The chemical conversion treatment of the aluminum alloy foil was performed by applying to both the surfaces of the aluminum alloy foil a treatment liquid including a phenol resin, a chromium fluoride compound and phosphoric acid using a roll coating method in such a manner that the application amount of chromium was 10 mg/m² (dry mass), and performing baking.

Next, maleic anhydride-modified polypropylene as an adhesive layer (thickness: 22.5 μm) and random polypropylene as a heat-sealable resin layer (thickness: 22.5 μm) were laminated onto the barrier layer of each of the obtained laminates to obtain an exterior material for electrical storage devices in which a base material layer (25 μm), an adhesive agent layer (3 μm), a barrier layer (40 μm), an adhesive layer (22.5 μm) and a heat-sealable resin layer (22.5 μm) are laminated in this order.

### <Measurement of Heat Shrinkage Ratio of Stretched Nylon Film>

For ONy films A, B, C and D used in examples and comparative examples, the heat shrinkage ratio (machine direction, transverse direction, 45° direction and 135° direction) was measured under the conditions of a test temperature of 160° C. and a heating time of 30 minutes in a method conforming to the provisions of JIS Z 1714: 2009. The average of values determined for the three test samples is taken as a heat shrinkage ratio, and shown in Table 1.

### <Measurement of Moisture and Heat Shrinkage Ratio of Stretched Nylon Film>

For ONy films A, B, C and D used in examples and comparative examples, the moisture and heat shrinkage ratio (machine direction, transverse direction, 45° direction and 135° direction) was measured under the conditions of a test temperature of 85° C. and a relative humidity of 85% RH and a heating time of 2 hours in a method conforming to the provisions of JIS Z 1714: 2009. The average of values determined for the three test samples is taken as a moisture and heat shrinkage ratio, and shown in Table 1.

TABLE 1

| | Heat shrinkage ratio (%) | | | | Moisture and heat shrinkage (%) | | | |
|---|---|---|---|---|---|---|---|---|
| | (160° C., 30 minutes) | | | | (85° C., 85% RH, 2 hours) | | | |
| | MD | TD | 45° | 135° | MD | TD | 45° | 135° |
| ONy film A (15 μm) | 1.1 | 1.7 | 0.4 | 1.9 | 0.9 | 1.1 | 0.5 | 1.7 |
| ONy film B (15 μm) | 2.5 | 2.2 | 1.0 | 3.1 | 1.7 | 1.3 | 0.8 | 2.1 |
| ONy film C (15 μm) | 2.1 | 1.5 | 1.5 | 2.3 | 1.5 | 0.9 | 0.8 | 1.5 |
| ONy film D (25 μm) | 1.6 | 2.2 | 1.4 | 1.9 | 0.9 | 1.1 | 1.0 | 1.1 |

### <Heat Resistance Evaluation 1>

As specified in JIS K 7127: 1999, the peeling strength of the exterior material for electrical storage devices at each of temperatures shown in Tables 2 and 3 (room temperature (25° C.) or 120° C.) was measured as follows. From each exterior material for electrical storage devices, a test sample was cut into a strip shape having a width of 15 mm (transverse direction) and a length of 150 mm (machine direction). The MD of the exterior material for electrical storage devices corresponds to the rolling direction (RD) of the aluminum alloy foil, the TD of the exterior material for electrical storage devices corresponds to the TD of the aluminum alloy foil. Next, at a short-side portion of the test sample on one side thereof, the test sample was delaminated at the interface between the adhesive agent layer and the barrier layer to the extent that it was possible to grip the test sample with a gripping tool of a tensile tester (AG-X plus (trade name) manufactured by Shimadzu Corporation) on each of a side where the base material layer was present and a side where the barrier layer was present, thereby obtaining a measuring test sample. Next, the measuring test sample was attached to the tensile tester and left to stand at each measurement temperature for 2 minutes, and subsequently, the peeling strength (N/15 mm) between the base material layer and the barrier layer was measured by the tensile tester under the conditions of peeling by 180°, a tensile speed of 50 mm/min, and a gauge length of 50 mm. The strength at a gauge length of 57 mm was taken as a peeling strength (N/15 mm). The average of values obtained by measuring the peeling strength (N/15 mm) three times is shown in Tables 2 and 3. The ratio (%) of the peeling strength at a temperature of 120° C. to the peeling strength at room temperature is shown in Tables 2 and 3. Evaluation criteria for heat resistance at room temperature and a temperature of 120° C. are as follows.

### (Evaluation Criteria for Heat Resistance at Room Temperature)

A: Peeling strength is 5.0 N/15 mm or more

C: Peeling strength is less than 5.0 N/15 mm

### (Evaluation Criteria for Heat Resistance at Temperature of 120° C.)

A: Peeling strength is 3.0 N/15 mm or more

C: Peeling strength is less than 3.0 N/15 mm

### <Evaluation of Moldability>

For each of the exterior materials for electrical storage devices, a test sample in which erucic acid amide was applied as a slipping agent to each of both surfaces (the surface of the base material layer and the surface of the heat-sealable resin layer) of the exterior material for electrical storage devices (with slipping agent) and a test sample in which the slipping agent was not applied (without slipping agent) were prepared, and subjected to cold molding. First, each exterior material for electrical storage devices was cut to a rectangle having a length of 90 mm (machine direction) and a width of 150 mm (transverse direction) to obtain a test sample. The MD of the exterior material for electrical storage devices corresponds to the rolling direction (RD) of the aluminum alloy foil, the TD of the exterior material for electrical storage devices corresponds to the TD of the aluminum alloy foil. Next, using a rectangular mold having an opening size of 31.6 mm (machine direction)×54.5 mm (transverse direction) (female; the surface has a roughness in maximum height (nominal value of Rz) of 3.2 μm as specified in Appendix 1 (Reference) of JIS B 0659-1: 2002, Comparative Surface Roughness Standard Specimen, Table 2; the curvature radius R of the corner is 2.0 mm; and the curvature radius R of the ridge line is 1.0 mm), and a corresponding mold (male; surface of the ridge line portion has a roughness in maximum height (nominal value of Rz) of 1.6 μm as specified in Appendix 1 (Reference) of JIS B 0659-1: 2002, Comparative Surface Roughness Standard Specimen, Table 2; the surface of a non-ridge line portion has a roughness in maximum height (nominal value of Rz) of 3.2 μm as specified in Appendix 1 (Reference) of JIS B 0659-1: 2002, Comparative Surface Roughness Standard Specimen, Table 2; the curvature radius R of the corner is 2.0 mm; and the curvature radius R of the ridge line is 1.0 mm), each sample was subjected to cold molding (draw molding in one stage) at each molding depth (5.0 mm to 8.5 mm) shown in Tables 2 and 3 under a pressing pressure (surface pressure) of 0.25 MPa in an environment at 25° C. This procedure is carried out for 10 test samples. At this time, the molding was performed at room temperature (25° C.) with the test sample placed on the female mold in such a manner that the heat-sealable resin layer was located on the male mold side. The male mold and the female mold had a clearance of 0.3 mm. For the test sample after cold molding, light was applied with a penlight in a dark room, and whether or not pinholes or cracks were generated in the aluminum alloy foil was checked on the basis of transmission of light, and the number of test samples having pinholes and cracks, among 10 or more test samples, was determined. In Tables 2 and 3, for example, “2/10” is written in the case where among a total of 10 test samples subjected to cold molding, 2 test samples had pinholes and cracks. The evaluation criteria for moldability are as follows. When rated A or B, the exterior material for electrical storage devices has cold-moldability.

A: The ratio of test samples having pinholes and cracks is 0/10

B: The ratio of test samples having pinholes and cracks is 1/10 to 4/10

C: The ratio of test samples having pinholes and cracks is 5/10 to 10/10

For the cold-molded exterior material for electrical storage devices, the deepest of depths at which none of the 10 test samples had pinholes and cracks in the aluminum alloy foil was defined as A mm, and the number of test samples having pinholes etc. at the shallowest of depths where pinholes etc. were generated in the aluminum alloy foil was defined as B. The value calculated from the following equation was rounded off to one decimal place, and the resulting value was defined as a limit molding depth of the exterior material for electrical storage devices. Tables 2 and 3 show the results.

Limit molding depth=A mm+(0.5 mm/10 pieces)×(10 pieces−B pieces)

### <Heat Resistance Evaluation 2>

In the same manner as in <Evaluation of moldability> described above, a test sample obtained by cutting each exterior material for electrical storage devices to a rectangle having a length of 90 mm (machine direction)×a width of 160 mm (transverse direction) was subjected to cold molding using the above-described mold. In Examples 1 to 4 and Comparative Examples 2 to 4, the molding depth was 5.0 mm, and in Example 5 and Comparative Example 6, the molding depth was 7.0 mm. A slipping agent was not applied to either of both surfaces of each cold-molded exterior material for electrical storage devices. Next, as shown in the schematic diagram of FIG. 6, the test sample after cold molding was bent at the position of broken line P in such a manner that a molding concave portion 21 of a test sample 20 was on the inner side (heat-sealable resin layers faced each other) (FIGS. 6(a) and 6(b)). Next, along the outer edge of the molding concave portion, heat sealing was performed at two positions in the transverse direction and the machine direction in this order (FIG. 6(c)). In FIG. 6, the heat-sealed portion S1 in the transverse direction and the heat-sealed portion S2 in the machine direction are each indicated by a shaded region. The heat-sealing conditions were set to 190° C. or 210° C. (temperature shown in Tables 2 and 3), a surface pressure of 1.0 MPa, 3 seconds, and a seal width of 7 mm. For the heat-sealed test sample, whether or not delamination between the base material layer and the barrier layer (delamination of the base material layer) occurs was visually examined. Tables 2 and 3 show the ratios of test samples undergoing the delamination in 10 test samples. The criteria of heat resistance evaluation 2 are as follows. When rated A or B, the cold-molded exterior material for electrical storage devices has high heat resistance.

A: The ratio of test samples undergoing delamination is 0/10

B: The ratio of test samples undergoing delamination is 1/10 to 4/10

C: The ratio of test samples undergoing delamination is 5/10 to 10/10

<Evaluation of Moisture and Heat Resistance after Molding>

The moisture and heat resistance of the cold-molded exterior material for electrical storage devices was evaluated in the following moisture and heat resistance evaluations 1 to 3.

### (Moisture and Heat Resistance Evaluation 1: Temperature of 65° C. and Relative Humidity of 90% RH)

In the same manner as in <Evaluation of moldability> described above, a test sample obtained by cutting each exterior material for electrical storage devices to a rectangle having a length of 90 mm (machine direction)×a width of 160 mm (transverse direction) was subjected to cold molding using the above-described mold. In Examples 1 to 4 and Comparative Examples 2 to 4, the molding depth was 5.0 mm, and in Example 5 and Comparative Example 6, the molding depth was 7.0 mm. A slipping agent was not applied to either of both surfaces of each cold-molded exterior material for electrical storage devices. Next, as shown in the schematic diagram of FIG. 6, the test sample after cold molding was bent at the position of broken line P in such a manner that a molding concave portion 21 of a test sample 20 was on the inner side (heat-sealable resin layers faced each other) (FIGS. 6(a) and 6(b)). Next, along the outer edge of the molding concave portion, heat sealing was performed at two positions in the transverse direction and the machine direction in this order (FIG. 6(c)). In FIG. 6, the heat-sealed portion S1 in the transverse direction and the heat-sealed portion S2 in the machine direction are each indicated by a shaded region. The heat-sealing conditions were set to a temperature of 190° C., a surface pressure of 1.0 MPa, 3 seconds, and a seal width of 7 mm. Next, the heat-sealed test sample was put in a constant-temperature and constant-humidity bath in an atmosphere at a temperature of 65° C. and a relative humidity of 90% RH, and left standing for 72 hours (3 days). The test sample was taken out from the constant-temperature and constant-humidity bath, and whether or not delamination between the base material layer and the barrier layer (delamination of the base material layer) occurs was visually examined. Tables 2 and 3 show the ratios of test samples undergoing the delamination in 10 test samples. The criteria of moisture and heat resistance evaluation 1 are as follows. When rated A or B, the cold-molded exterior material for electrical storage devices has high moisture and heat resistance.

A: The ratio of test samples undergoing delamination is 0/10

B: The ratio of test samples undergoing delamination is 1/10 to 4/10

C: The ratio of test samples undergoing delamination is 5/10 to 10/10

### (Moisture and Heat Resistance Evaluation 2: Temperature of 85° C. and Relative Humidity of 85% RH)

Except that with respect to the moisture and heat resistance evaluation 1, “the sample was put in a constant-temperature and constant-humidity bath in an atmosphere at a temperature of 85° C. and a relative humidity of 85% RH, and left standing for 10 days, 20 days or 30 days” instead of “putting the sample in a constant-temperature and constant-humidity bath in an atmosphere at a temperature of 65° C. and a relative humidity of 90% RH, and leaving the sample standing for 72 hours”, the same procedure as in the moisture and heat resistance evaluation 1 was carried out to perform moisture and heat resistance evaluation 2. Tables 2 and 3 show the results. The evaluation criteria of moisture and heat resistance evaluation 2 are as follows.

A: The ratio of test samples undergoing delamination is 0/10

B: The ratio of test samples undergoing delamination is 1/10 to 4/10

C: The ratio of test samples undergoing delamination is 5/10 to 10/10

### (Moisture and Heat Resistance Evaluation 3: Saturated Water Vapor Environment at Temperature of 120° C.)

The exterior material for electrical storage devices is prepared as a test sample having a rectangular shape in plan view and having a size of 120 mm in the transverse direction and 80 mm in the machine direction. The number of the test samples was 12. As described above, the MD of the exterior material for electrical storage devices corresponds to the rolling direction (RD) of the aluminum alloy foil, the TD of the exterior material for electrical storage devices corresponds to the TD of the aluminum alloy foil. Next, as a mold for cold molding, a male mold having a rectangular shape in plan view and having a size of 54.5 mm in the transverse direction and 31.6 mm in the machine direction, and a female mold having a clearance of 0.5 mm from the male mold were prepared. In the male mold, the surface of a ridge line portion has a roughness in maximum height (nominal value of Rz) of 1.6 μm as specified in Appendix 1 (Reference) of JIS B 0659-1: 2002, Comparative Surface Roughness Standard Specimen, Table 2), the surface of a non-ridge line portion has a roughness in maximum height (nominal value of Rz) of 3.2 μm as specified in Appendix 1 (Reference) of JIS B 0659-1: 2002, Comparative Surface Roughness Standard Specimen, Table 2), the curvature radius R of the corner is 2.0 mm, and the curvature radius R of the ridge line is 1.0 mm. In the female mold, the surface has a roughness in maximum height (nominal value of Rz) of 3.2 μm as specified in Appendix 1 (Reference) of JIS B 0659-1: 2002, Comparative Surface Roughness Standard Specimen, Table 2), the curvature radius R of the corner is 2.0 mm, and the curvature radius R of the ridge line is 1.0 mm. The test sample is placed on the female mold such that the heat-sealable resin layer of the test sample is located on the male mold side. Next, the test sample was pressed at a surface pressure of 0.13 MPa and subjected to cold molding by drawing in one stage. In Examples 1 to 4 and Comparative Examples 2 to 4, the molding depth was 5.0 mm, and in Example 5 and Comparative Example 6, the molding depth was 6.5 mm. Next, the test sample after cold molding was put in an autoclave. The environment of the inside of the autoclave was set to a saturated water vapor environment at a temperature of 120° C., and the test sample was left standing for a predetermined time as shown in Tables 2 and 3 (8 hours, 10 hours or 12 hours). Next, the test sample was taken out from the autoclave, and the interface between the base material layer and the barrier layer was visually observed to examine whether or not delamination occurred between these layers. The ratios of test samples undergoing delamination in 12 test samples are shown in Tables 2 and 3. The evaluation criteria of moisture and heat resistance evaluation 3 are as follows.

A: The ratio of test samples undergoing delamination is 0/12

B: The ratio of test samples undergoing delamination is 1/12 to 4/12

C: The ratio of test samples undergoing delamination is 5/12 to 12/12

TABLE 2

| | | | | | | Compar- | Compar- | Compar- | Compar- |
|---|---|---|---|---|---|---|---|---|---|
| | | | | | | ative | ative | ative | ative |
| | | Example 1 | Example 2 | Example 3 | Example 4 | Example 1 | Example 2 | Example 3 | Example 4 |
| Stretched nylon film of base material layer | | ONy A | ONy A | ONy B | ONy B | ONy A | ONy A | ONy B | ONy C |
| Two-liquid urethane adhesive of adhesive | | Adhe- | Adhe- | Adhe- | Adhe- | Adhe- | Adhe- | Adhe- | Adhe- |
| agent layer | | sive A | sive A | sive A | sive B | sive C | sive D | sive D | sive D |
| Barrier layer (aluminum alloy layer) | | A | B | A | A | A | A | A | B |
| Heat resistance | Peeling strength | A | A | A | A | — | A | A | A |
| evaluation 1 | at 25° C. | 8.6 | 8.4 | 8.1 | 7.5 | | 9.2 | 9.2 | 9.0 |
| | (N/15 mm) | | | | | | | | |
| | Peeling strength | A | A | A | C | — | A | A | A |
| | at 120° C. | 5.1 | 5.0 | 3.5 | 2.8 | | 4.9 | 4.9 | 4.8 |
| | (N/15 mm) | | | | | | | | |
| | Ratio of peeling | 59 | 60 | 43 | 32 | — | 53 | 53 | 53 |
| | strength at temperature | | | | | | | | |
| | of 120° C. to peeling | | | | | | | | |
| | strength at room | | | | | | | | |
| | temperature (%) | | | | | | | | |
| Moldability | Molding depth: | A | A | A | A | — | A | A | A |
| (without slipping | 5.0 mm | 0/10 | 0/10 | 0/10 | 0/10 | | 0/10 | 0/10 | 0/10 |
| agent) | Molding depth: | B | B | A | B | — | B | B | B |
| | 5.5 mm | 1/10 | 4/10 | 0/10 | 2/10 | | 3/10 | 3/10 | 2/10 |
| | Molding depth: | B | B | B | C | — | C | B | B |
| | 6.0 mm | 2/10 | 4/10 | 2/10 | 6/10 | | 6/10 | 4/10 | 3/10 |
| | Limit molding | 5.5 | 5.3 | 5.9 | 5.4 | — | 5.4 | 5.4 | 5.4 |
| | depth (mm) | | | | | | | | |
| Moldability | Molding depth: | A | A | A | A | — | A | A | A |
| (with slipping | 7.0 mm | 0/10 | 0/10 | 0/10 | 0/10 | | 0/10 | 0/10 | 0/10 |
| agent) | Molding depth: | A | A | A | A | — | B | B | B |
| | 7.5 mm | 0/10 | 0/10 | 0/10 | 0/10 | | 2/10 | 2/10 | 1/10 |
| | Molding depth: | B | B | B | B | — | — | — | B |
| | 8.0 mm | 1/10 | 2/10 | 3/10 | 2/10 | | | | 1/10 |
| | Limit molding | 8.0 | 7.9 | 7.9 | 7.9 | — | 7.4 | 7.4 | 7.5 |
| | depth (mm) | | | | | | | | |
| Heat resistance | 190° C. | A | A | A | A | — | A | A | A |
| evaluation 2 | | 0/10 | 0/10 | 0/10 | 0/10 | | 0/10 | 0/10 | 0/10 |
| Heat-sealing after | 210° C. | A | A | A | B | — | A | A | A |
| molding | | 0/10 | 0/10 | 0/10 | 4/10 | | 0/10 | 0/10 | 0/10 |
| Moisture and heat | After 3 days | A | A | A | A | A | A | A | A |
| resistance evaluation 1 | | 0/10 | 0/10 | 0/10 | 0/10 | 0/10 | 0/10 | 0/10 | 0/10 |
| Temperature: 65° C. | | | | | | | | | |
| Relative humidity: | | | | | | | | | |
| 90% RH | | | | | | | | | |
| Moisture and heat | After 10 days | A | A | A | A | A | A | A | A |
| resistance evaluation 2 | | 0/10 | 0/10 | 0/10 | 0/10 | 0/10 | 0/10 | 0/10 | 0/10 |
| Temperature: 85° C. | After 20 days | A | A | A | A | A | B | C | C |
| Relative humidity: | | 0/10 | 0/10 | 0/10 | 0/10 | 0/10 | 4/10 | 7/10 | 5/10 |
| 85% RH | After 30 days | A | A | A | A | A | C | C | C |
| | | 0/10 | 0/10 | 0/10 | 0/10 | 0/10 | 10/10 | 10/10 | 10/10 |
| Moisture and heat | 8 h | A | A | A | A | A | B | B | A |
| resistance evaluation 3 | | 0/12 | 0/12 | 0/12 | 0/12 | 0/12 | 1/12 | 1/12 | 0/12 |
| Temperature: 120° C. | 10 h | A | A | A | A | A | C | C | C |
| Saturated water vapor | | 0/12 | 0/12 | 0/12 | 0/12 | 0/12 | 8/12 | 5/12 | 5/12 |
| environment | 12 h | B | A | A | A | A | C | C | C |
| | | 1/12 | 0/12 | 0/12 | 0/12 | 0/12 | 12/12 | 7/12 | 7/12 |

TABLE 3

| | | | Comparative | Comparative |
|---|---|---|---|---|
| | | Example 5 | Example 5 | Example 6 |
| Stretched nylon film of base material layer | | ONy D | ONy D | ONy D |
| Two-liquid urethane adhesive of adhesive | | Adhesive A | Adhesive C | Adhesive D |
| agent layer | | | | |
| Barrier layer (aluminum alloy layer) | | B | B | B |
| Heat resistance | Peeling strength | A | — | A |
| evaluation 1 | at 25° C. | 5.3 | | 6.2 |
| | (N/15 mm) | | | |
| | Peeling strength | A | — | A |
| | at 120° C. | 3.4 | | 4.4 |
| | (N/15 mm) | | | |
| | Ratio of peeling | 64 | — | 71 |
| | strength at temperature | | | |
| | of 120° C. to peeling | | | |
| | strength at room | | | |
| | temperature (%) | | | |
| Moldability | Molding depth: | A | — | A |
| (without slipping | 7.0 mm | 0/10 | | 0/10 |
| agent) | Molding depth: | A | — | B |
| | 7.5 mm | 0/10 | | 1/10 |
| | Molding depth: | B | — | B |
| | 8.0 mm | 1/10 | | 3/10 |
| | Limit molding | 8.0 | — | 7.5 |
| | depth (mm) | | | |
| Moldability | Molding depth: | A | — | A |
| (with slipping agent) | 7.5 mm | 0/10 | | 0/10 |
| | Molding depth: | A | — | B |
| | 8.0 mm | 0/10 | | 2/10 |
| | Molding depth: | B | — | B |
| | 8.5 mm | 1/10 | | 3/10 |
| | Limit molding | 8.5 | — | 7.9 |
| | depth (mm) | | | |
| Heat resistance | 190° C. | A | — | A |
| evaluation 2 | | 0/10 | | 0/10 |
| Heat-sealing after | 210° C. | A | — | A |
| molding | | 0/10 | | 0/10 |
| Moisture and heat | After 3 days | A | A | A |
| resistance evaluation 1 | | 0/10 | 0/10 | 0/10 |
| Temperature: 65° C. | | | | |
| Relative humidity: | | | | |
| 90% RH | | | | |
| Moisture and heat | After 10 days | — | — | — |
| resistance evaluation 2 | After 20 days | — | — | — |
| Temperature: 85° C. | After 30 days | | | |
| Relative humidity: | | | | |
| 85% RH | | | | |
| Moisture and heat | 8 h | A | A | C |
| resistance evaluation 3 | | 0/12 | 0/12 | 10/12 |
| Temperature: 120° C. | 10 h | A | A | C |
| Saturated water vapor | | 0/12 | 0/12 | 12/12 |
| environment | 12 h | B | A | C |
| | | 3/12 | 0/12 | 12/12 |

In Tables 2 and 3, the expression of “-” means that measurement was not performed. In each of Comparative Examples 1 and 5, evaluation of moldability was not performed and evaluation of heat resistance was omitted because an adhesive for back sheets of solar cells was used as an adhesive for forming an adhesive agent layer, and the adhesive was excellent in moisture and heat resistance, but did not have cold moldability (i.e. all of test samples subjected to the cold molding at a molding depth of 5.0 mm had pinholes and cracks. In Comparative Examples 1 and 5, moisture and heat resistance evaluations 1 to 3 were performed without subjecting the test sample to cold molding.

As shown in Tables 2 and 3, it can be seen that in the exterior materials for electrical storage devices in Examples 1 to 5, the adhesive agent layer bonding the base material layer and the barrier layer to each other has high moisture and heat resistance because the cold-molded exterior material for electrical storage devices has high moisture and heat resistance (e.g. moisture and heat resistance in a saturated water vapor environment at a temperature of 120° C.). In the exterior materials for electrical storage devices in Examples 1 to 5, the adhesive agent layer bonding the base material layer and the barrier layer to each other has moisture and heat resistance, and the exterior material for electrical storage devices is cold-moldable.

On the other hand, it can be seen that the exterior materials of Comparative Examples 1 and 5 using an adhesive for solar cells, which is excellent in moisture and heat resistance, is not cold-moldable, and therefore cannot be used for an exterior material for electrical storage devices which is subjected to cold molding. It was revealed that the exterior materials of Comparative Examples 2-4 and 6 were excellent in heat resistance, but dis not have sufficient moisture and heat resistance because an adhesive that is used for exterior materials for in-vehicle electrical storage devices, which have high heat resistance and moldability after curing, was used.

As described above, the present disclosure provides the invention of aspects as shown below.

Item 1. An exterior material for electrical storage devices including a laminate including at least a base material layer, an adhesive agent layer, a barrier layer and a heat-sealable resin layer in this order,

the adhesive agent layer having moisture and heat resistance,

the laminate being cold-moldable.

Item 2. The exterior material for electrical storage devices according to item 1, in which the adhesive agent layer has moisture and heat resistance in a saturated water vapor environment at a temperature of 120° C.

Item 3. The exterior material for electrical storage devices according to item 1 or 2, in which when the following method for evaluation of moisture and heat resistance is used to examine delamination between the base material layer and the barrier layer in the exterior material for electrical storage devices after cold molding, the number of test samples undergoing the delamination, among a total of 12 samples of the exterior material for electrical storage devices is 4 or less:

### (Method for Evaluation of Moisture and Heat Resistance)

an exterior material for electrical storage devices is used as a test sample; the number of the test samples is 12; next, as a mold for cold molding, a male mold having a rectangular shape in plan view and having a size of 54.5 mm in the transverse direction and 31.6 mm in the machine direction, and a female mold having a clearance of 0.5 mm from the male mold are prepared; the test sample is placed on the female mold such that the heat-sealable resin layer of the test sample is located on the male mold side; next, the test sample is pressed at a surface pressure of 0.13 MPa and subjected to cold molding by drawing in one stage; next, the test sample after cold molding is put in an autoclave; the environment of the inside of the autoclave is set to a saturated water vapor environment at a temperature of 120° C., and the test sample is left standing for 10 hours; and next, the test sample is taken out from the autoclave, and the interface between the base material layer and the barrier layer is visually observed to examine whether or not delamination occurs between these layers.

Item 4. The exterior material for electrical storage devices according to any one of items 1 to 3, in which a glass transition temperature of the adhesive agent layer is 40° C. or higher and 150° C. or lower.

Item 5. The exterior material for electrical storage devices according to any one of items 1 to 3, in which a glass transition temperature of the adhesive agent layer is 111° C. or higher and 139° C. or lower.

Item 6. The exterior material for electrical storage devices according to any one of items 1 to 5, for use as an exterior material for outdoor electrical storage devices.

Item 7. An electrical storage device in which an electrical storage device element including at least a positive electrode, a negative electrode and an electrolyte is stored in a packaging formed of the exterior material for electrical storage devices according to any one of items 1 to 6.

Item 8. A method for manufacturing an exterior material for electrical storage devices, including the step of laminating at least a base material layer, an adhesive agent layer, a barrier layer and a heat-sealable resin layer in this order to obtain a laminate, the adhesive agent layer having moisture and heat resistance, the laminate being cold-moldable.

### DESCRIPTION OF REFERENCE SIGNS

1: Base material layer
2: Adhesive agent layer
3: Barrier layer
4: Heat-sealable resin layer
5: Adhesive layer
6: Surface coating layer
10: Exterior material for electrical storage devices

1. An exterior material for electrical storage devices comprising a laminate including at least a base material layer, an adhesive agent layer, a barrier layer and a heat-sealable resin layer in this order,
the adhesive agent layer having moisture and heat resistance,
the laminate being cold-moldable.

2. The exterior material for electrical storage devices according to claim 1, wherein the adhesive agent layer has moisture and heat resistance in a saturated water vapor environment at a temperature of 120° C.

3. The exterior material for electrical storage devices according to claim 1, wherein when the following method for evaluation of moisture and heat resistance is used to examine delamination between the base material layer and the barrier layer in the exterior material for electrical storage devices after cold molding, the number of test samples undergoing the delamination, among a total of 12 samples of the exterior material for electrical storage devices is 4 or less:
(method for evaluation of moisture and heat resistance)
an exterior material for electrical storage devices is used as a test sample; the number of the test samples is 12; next, as a mold for cold molding, a male mold having a rectangular shape in plan view and having a size of 54.5 mm in the transverse direction and 31.6 mm in the machine direction, and a female mold having a clearance of 0.5 mm from the male mold are prepared; the test sample is placed on the female mold such that the heat-sealable resin layer of the test sample is located on the male mold side; next, the test sample is pressed at a surface pressure of 0.13 MPa and subjected to cold molding by drawing in one stage; next, the test sample after cold molding is put in an autoclave; the environment of the inside of the autoclave is set to a saturated water vapor environment at a temperature of 120° C., and the test sample is left standing for 10 hours; and next, the test sample is taken out from the autoclave, and the interface between the base material layer and the barrier layer is visually observed to examine whether or not delamination occurs between these layers.

4. The exterior material for electrical storage devices according to claim 1, wherein a glass transition temperature of the adhesive agent layer is 40° C. or higher and 150° C. or lower.

5. The exterior material for electrical storage devices according to claim 1, wherein a glass transition temperature of the adhesive agent layer is 111° C. or higher and 139° C. or lower.

6. The exterior material for electrical storage devices according to claim 1, for use as an exterior material for outdoor electrical storage devices.

7-8. (canceled)

9. The exterior material for electrical storage devices according to claim 1, wherein the base material layer contains a polyester film and a polyamide film.

10. The exterior material for electrical storage devices according to claim 1, wherein two or more slipping agents are present on at least one of a surface of the base material layer and an inside of the base material layer.

11. The exterior material for electrical storage devices according to claim 1,
wherein the base material layer has a thickness of 50 μm or less, and
the thickness of the base material layer is 35 μm or less, or
the thickness of the base material layer is more than 35 μm and 50 μm or less.

12. The exterior material for electrical storage devices according to claim 1,
wherein the barrier layer has a thickness of 200 μm or less, and
the thickness of the barrier layer is 50 μm or less, or
the thickness of the barrier layer is more than 50 μm and 200 μm or less.

13. The exterior material for electrical storage devices according to claim 1,
wherein a slipping agent is present on a surface of the heat-sealable resin layer, and
an amount of the slipping agent present is 10 mg/m² or more.

14. The exterior material for electrical storage devices according to claim 1, wherein the heat-sealable resin layer contains a resin containing a polyolefin backbone.

15. The exterior material for electrical storage devices according to claim 1, wherein the heat-sealable resin layer contains at least one selected from the group consisting of a polyolefin, a cyclic polyolefin, an acid-modified polyolefin, and an acid-modified cyclic polyolefin.

16. The exterior material for electrical storage devices according to claim 1, wherein the heat-sealable resin layer contains a blend polymer that is a combination of two or more resins.

17. The exterior material for electrical storage devices according to claim 1, wherein the heat-sealable resin layer includes two or more layers with one resin component or different resin components.

18. The exterior material for electrical storage devices according to claim 1, wherein two or more slipping agents are present on at least one of a surface of the heat-sealable resin layer and an inside of the heat-sealable resin layer.

19. The exterior material for electrical storage devices according to claim 1, wherein at least two selected from the group consisting of a saturated fatty acid amide, an unsaturated fatty acid amide, a substituted amide, a methylol amide, a saturated fatty acid bisamide, an unsaturated fatty acid bisamide, a fatty acid ester amide, and an aromatic bisamide are present on at least one of a surface of the heat-sealable resin layer and an inside of the heat-sealable resin layer.

20. The exterior material for electrical storage devices according to claim 1, wherein the barrier layer includes at least one of an aluminum alloy foil and a stainless steel foil.

21. The exterior material for electrical storage devices according to claim 1,
wherein the heat-sealable resin layer contains at least one selected from the group consisting of a polyolefin, a cyclic polyolefin, an acid-modified polyolefin, and an acid-modified cyclic polyolefin, and
the heat-sealable resin layer contains a blend polymer that is a combination of two or more resins.

22. An electrical storage device in which an electrical storage device element including at least a positive electrode, a negative electrode and an electrolyte is stored in a packaging formed of the exterior material for electrical storage devices according to claim 1.

23. A method for manufacturing an exterior material for electrical storage devices, comprising the step of laminating at least a base material layer, an adhesive agent layer, a barrier layer and a heat-sealable resin layer in this order to obtain a laminate,
the adhesive agent layer having moisture and heat resistance,
the laminate being cold-moldable.

24. The method for manufacturing an exterior material for electrical storage devices according to claim 23,
wherein the laminate includes an adhesive layer between the barrier layer and the heat-sealable resin layer, and
the adhesive layer and the heat-sealable resin layer are formed by a co-extrusion lamination method, a tandem lamination method, a thermal lamination method, a sandwich lamination method, or a method in which an adhesive for forming the adhesive layer is applied to the barrier layer by solution coating, and the heat-sealable resin layer formed in a sheet shape in advance is laminated on the adhesive layer.

25. The method for manufacturing an exterior material for electrical storage devices according to claim 23,
wherein the laminate includes an adhesive layer between the barrier layer and the heat-sealable resin layer, and
the heat-sealable resin layer includes two or more layers with one resin component or different resin components.
